(19) United States
(12) Patent Application Publication
(10) Pub. No.: US 2013/0110407 A1
(43) Pub. Date: May 2, 2013

(54) DETERMINING VARIANTS IN GENOME OF A HETEROGENEOUS SAMPLE

(71) Applicants: Jonathan Baccash, Los Altos, CA (US); Aaron Halpern, San Carlos, CA (US); Chao Tian, Sunnyvale, CA (US); Krishna Pant, San Jose, CA (US); Paolo Carnevali, San Jose, CA (US)

(72) Inventors: Jonathan Baccash, Los Altos, CA (US); Aaron Halpern, San Carlos, CA (US); Chao Tian, Sunnyvale, CA (US); Krishna Pant, San Jose, CA (US); Paolo Carnevali, San Jose, CA (US)

(73) Assignee: Complete Genomics, Inc., Mountain View, CA (US)

(21) Appl. No.: 13/621,716

(22) Filed: Sep. 17, 2012

Related U.S. Application Data
(60) Provisional application No. 61/535,926, filed on Sep. 16, 2011.
(60) Provisional application No. 61/606,306, filed on Mar. 2, 2012.

(51) Int. Cl. G06F 17/18

(52) U.S. Cl. CPC G06F 17/18
USPC 702/19

(57) ABSTRACT

After DNA fragments are sequenced and mapped to a reference, various hypotheses for the sequences in a variant region can be scored to find which sequence hypotheses are more likely. A hypothesis can include a specific variable fraction for the plurality of alleles that comprise the sequence hypothesis in the region. A likelihood of each hypothesis can be determined using a probability that accounts for the fraction of the alleles specified in the respective sequence hypothesis. Thus, other hypotheses besides standard homozygous and equal heterozygous (i.e., one chromosome with A and one with B in a cell) can be explored by explicitly including the variable fractions of the alleles as a parameter in the optimization. Also, a variant score can be determined for a variant relative to a reference. The variant score can be used to determine a variant calibrated score indicating a likelihood that the variant call is correct.

### CROSS-REFERENCES TO RELATED APPLICATIONS

The present application claims priority from and is a nonprovisional application of U.S. Provisional Application No. 61/535,926 entitled “Techniques For Calling Small Variants In Polynucleotide Sequences” filed Sep. 16, 2011, and Provisional Application No. 61/606,306 entitled “Techniques For Small Variant Assembler” filed Mar. 2, 2012, the entire contents of which are herein incorporated by reference for all purposes.

This application is related to commonly owned U.S. patent application Ser. No. 12/770,089 entitled “Method And System For Calling Variations In A Sample Polynucleotide Sequence With Respect To A Reference Polynucleotide Sequence” by Carnevali et al. (attorney docket number 92171-002110US), filed Apr. 29, 2010, the disclosure of which is incorporated by reference in its entirety.

### BACKGROUND

The present disclosure relates generally to determining a genome using sequencing techniques, and more specifically to determining variants in a genome relative to another genome.

Non-tumor biological samples are largely diploid, where a variation may occur in one or both of the chromosomes. Conventionally, a variation in the sample genome at a particular gene relative to a reference genome is identified as heterozygous (1 mutant allele and 1 normal allele) or homozygous (2 mutant alleles). However, this is often not the case within tumor cells like cancer. During cell division, mutations can occur and as a result the genomes of some tumor cells can differ from the genomes of other tumor cells. Samples often exhibit such heterogeneity due to contamination with normal DNA and/or multiple branches in the tumor evolution. This heterogeneity in a sample can cause difficulty in determining all of the mutations in the genome of the sample.

It is therefore desirable to provide methods, systems, and apparatuses that can more accurately determine the genomic makeup of a sample that exhibits heterogeneity, particularly identify variations in a sample (e.g., a tumor sample) relative to a reference genome or a normal genome of a patient.

### BRIEF SUMMARY

Embodiments of the present invention provides techniques for identifying variants in a genome. For example, after DNA fragments have been sequenced and mapped to a reference genome and a variant region (region likely containing a variant) identified, various hypotheses for the sequences in the variant region can be scored to find which hypotheses are more likely. A sequence hypothesis for a region can include a specific variable fraction for the plurality of alleles that comprise the sequence hypothesis. A likelihood of each sequence hypothesis for the variant region can be determined using a probability that accounts for the fraction of the alleles (e.g., 20% A: 80% B) specified in the respective sequence hypothesis. Thus, other hypotheses besides standard homozygous and equal heterozygous (i.e., one chromosome with A and one with B in a cell) can be explored by explicitly including the variable fractions of the alleles as a parameter in the optimization. In this manner, the genomic makeup of a tumor sample exhibiting heterogeneity among the genomes of the sample cells can be more accurately determined.

Additionally, a variant score can be determined for a variant relative to a reference. Further, the variant score can be used to determine a variant calibrated score that indicates a likelihood that the variant call is correct. Such a variant calibrated score can be determined by determining variants from two sequencing runs of a same sample, identifying discordant loci where a variant is seen on one genome but not the second genome. The variant scores can then be grouped and a likelihood assigned to a range of variant scores (e.g., by using an iterative process that involves grouping reference scores of the genome). A somatic score of a variant identified in a tumor being a true somatic mutation can be quantified by comparing the tumor genome to a normal genome to identify discordant loci. Likelihoods of the tumor genome being a false positive and the normal genome being a false negative can be used to determine a likelihood of the variant being a true somatic mutation.

According to one embodiment, a computer-implemented method determines one or more variants between a reference genome and a sample genome of a biological sample from a diploid organism. Reads of the sample genome and mappings of the reads to the reference genome are received. The reads are obtained from a sequencing of a plurality of genomic fragments from the biological sample. A first region of the sample genome is identified that has a first likelihood of including one or more variants relative to a corresponding region in the reference genome, where the first likelihood is above a first threshold. A starting hypothesis of the sample genome in the first region is determined. A group of hypotheses of the sample genome in the first region is generated based on the starting hypothesis. At least one of the group of hypotheses includes a plurality of alleles and a respective allele fraction corresponding to each of the plurality of alleles. For each hypothesis in the group of hypotheses, a probability score is computed for the hypothesis using a probability function. The probability function receives an input of each allele of the hypothesis and the respective allele fraction. A first hypothesis in the group of hypotheses includes a first allele with a respective allele fraction between a minimum threshold fraction and 0.5. A top hypothesis is selected based on the probability scores. One or more variants between the reference genome and the sample genome are called for the first region based on the top hypothesis.

According to another embodiment, a computer-implemented method determines an error rate for a variant call in a genome of a sample. First variant calls and corresponding first variant scores are received. The first variant calls are called for a first genome that has been sequenced from a sample in a first sequencing operation. Second variant calls for a second genome that has been sequenced from the same sample in a second sequencing operation that is different than the first sequencing operation are received. Discordant loci at which there are discordances between the first genome and the second genome are determined based at least on the first variant calls and the second variant calls. The first variants are grouped based on the first variant scores into a first set of groups. A variation calibration score indicating a likelihood of a variant being a false positive is determined for each group of the first set. The variation calibration scores are stored for each group.

According to another embodiment, a computer-implemented method determines an error rate for a variant call in a genome of a sample. Reads of the sample genome and mappings of the reads to the reference genome are received. The reads are obtained from a sequencing of a plurality of genomic fragments from the biological sample. A first region of the sample genome is identified that has a first likelihood of including one or more variants relative to a corresponding region in the reference genome, where the first likelihood is above a first threshold. A top hypothesis is determined based on the probability scores of a plurality of hypotheses in the first region. A first variant score is calculated based on the top hypothesis and at least one other hypothesis. The first variant score are used to access a database table to obtain a calibrated score that indicates an error rate for the top hypothesis. The calibrated score corresponds to a range of variant scores that includes the first variant score.

According to another embodiment, a computer-implemented method identifies a somatic mutation in a first sample. A first set of variants with first variant scores that have been called for a first genome based on a sequencing of a first sample are received. A second set of variants with second variant scores that have been called for a second genome based on a sequencing of a second sample are received. One or more discordant loci at which a first variant exists in the first genome and a reference call exists in the second genome are determined based on the first set of variants and the second set of variants. For each of the discordant loci, a first likelihood that the first variant is a false positive is determined based on the corresponding first variant score. A second likelihood that the reference call is a false negative is determined based on the corresponding reference score. A somatic score representing a likelihood that the discordance between the first genome and the second genome is a somatic mutation as opposed to an error based on the first likelihood and the second likelihood is determined.

Other embodiments are directed to systems, portable consumer devices, and computer readable media associated with methods described herein.

A better understanding of the nature and advantages of the present invention may be gained with reference to the following detailed description and the accompanying drawings.

### BRIEF DESCRIPTION OF THE DRAWINGS

FIG. 1 is a block diagram illustrating an example system configured to perform the techniques described herein in accordance with various example embodiments.

FIG. 2 is a flowchart of a method 200 for determining one or more variants between a reference genome and a sample genome of a biological sample from a diploid organism according to embodiments of the present invention.

FIG. 3 is a block diagram illustrating an example method of iterative hypotheses scoring according to one embodiment.

FIG. 4 is a graph 400 illustrating different mixtures of different cells having different genomes.

FIG. 5 shows a diagram 500 of the genome of three different sample 501-503.

FIG. 6A shows a graph 600 illustrating a scenario where there are 40 DNBs in favor of the reference and 10 DNBs in favor of an alternative SNP according to embodiments of the present invention. FIG. 6B shows a graph 650 illustrating a scenario where there are 40 DNBs in favor of the reference and 5 DNBs in favor of an alternative SNP according to embodiments of the present invention.

FIG. 7 is a flowchart of a method 700 using variable allele fraction to determine possible variants in a sample genome according to embodiments of the present invention.

FIG. 8 is a graph 800 illustrating an example of the ROC for somatic events determined based on the techniques described herein.

FIG. 9 is a flowchart of a method 900 for determining an error rate for a variant call in a genome of a sample according to embodiments of the present invention.

FIG. 10 is a flowchart illustrating a method 1000 for determining a calibration score according to embodiments of the present invention.

FIG. 11A is a graph 1100 showing pre-smoothed convergence for the case of a single coverage bin according to embodiments of the present invention.

FIG. 11B is a graph 1150 showing the accuracy of method 1000.

FIG. 12A is a graph 1200 showing calibration scores for different coverages according to embodiments of the present invention.

FIG. 12B is a graph 1250 illustrating an example of how the 20% AF calibration compares to the 50% AF calibration, for coverage 40-50 according to embodiments of the present invention.

FIG. 13 is a flow diagram illustrating an example method 1300 of computing somatic scores according to one embodiment.

FIG. 14 shows a block diagram of an example computer system 1400 usable with system and methods according to embodiments of the present invention.

### DEFINITIONS

“Genome” refers to a sequence of data values representing the entire, or substantially entire, sequence of nucleotide bases that are present in the DNA of an organism; a genome typically includes data sequences representing both genes and non-coding regions of the DNA and/or RNA (ribonucleic acid).

“Reference polynucleotide sequence”, or simply “reference” or “reference sequence”, refers to a known sequence of data values representing nucleotide bases in a reference organism (e.g., such as a human organism). A reference may be the entire or substantially entire genome sequence (also referred to as a “reference genome”) of a reference organism, a portion of a reference genome, a consensus sequence of many reference organisms, a compilation sequence based on different components of different organisms, a collection of genome sequences drawn from a population of organisms, or any other appropriate sequence. A reference may also include information regarding variations from the reference known to be found in a population of organisms.

“Sample polynucleotide sequence”, or simply “sample sequence”, refers to a sequence of data values representing a nucleic acid sequence of a biological sample that may encompass a gene, a regulatory element, genomic DNA, cDNA, RNAs (including mRNAs, rRNAs, siRNAs, miRNAs and the like), and/or fragments thereof. A sample polynucleotide sequence may represent a nucleic acid physically present in a biological sample, or may represent a secondary nucleic acid such as a product (e.g., a concatemer) of an amplification reaction obtained during a library construction process. The sample sequences can form a “sample genome”. If the cells in the sample have different genomes, then the determined sample genome can be considered a “composite genome” of the genomes of cells in the sample. As the reads of two different sequencing runs can differ, the resultant genomes could differ (even if just by one base), even though a same sample is used, and also if two different samples are used from the same organism.

A “locus” (plural “loci”) corresponds to an identified location in a genome, and can span a single base or a sequential series of multiple bases. A locus is typically identified by using an identifier value or a range of identifier values with respect to a reference genome and/or a chromosome thereof; for example, the range of identifier values of “5100001” to “5800000” may refers to a particular location on chromosome 1 in the reference human genome. A “heterozygous locus” (also referred to as a “het”) is a locus in a genome, where the two copies of a chromosome do not have the same sequence. These different sequences at a locus are called “alleles”. A het can be a single-nucleotide polymorphism (SNP) if the reference genome location has two alleles that differ by a single base. A “het” can also be a reference genome location where there is an insertion or a deletion (collectively referred to as an “indel”) of one or more nucleotides or one or more tandem repeats. A “homozygous locus” is a locus in a reference or a baseline genome, where the two copies of a chromosome have the same allele. “Haplotype” of a chromosome refers to whether the chromosome is present once or twice in a genome; for a genome of cancer or other tumor cells, a chromosome haplotype may be a value that is non-integer and/or is greater than two. A “region” in a genome may include one or more loci.

A “fragment” refers to a nucleic acid molecule (e.g., DNA) that is included in, or derived from (e.g., via amplification), a biological sample that is extracted from a target organism such as, for example, a human being. Fragments can be of different lengths (e.g., shorter than 200 bps; 200-500 bps; 500-1 Kb where 1 Kb=1000 bps; 1 Kb-10 Kb, 10 Kb-50 Kb, 50 Kb-100 Kb, and longer than 100 Kb). “Sequencing” (also referred to as “sequence determination”) determines information identifying one or more sequences (reads) of nucleotides in the fragment. Such information may include the identification or determination of partial as well as full sequence information of the fragment. The sequence information may be determined with varying degrees of statistical reliability or confidence.

As used herein, a “read” refers to a set of one or more data values that represent one or more nucleotide bases. A read may be generated by a sequencing machine and/or associated logic that has performed a sequence determination of all or part of a nucleic acid fragment. A “mate pair” (also called “mated read” or “paired-end reads”) refers to at least two reads (also called “arm reads”) that have been determined from opposite ends of the same fragment. Two arm reads can be collectively called a mate pair, where a gap exists between the two arm reads with respect to the fragment from which that mate pair was sequenced. The two arm reads can be referred to individually as a “left” arm read and a “right” arm read; however, it is understood that any “left” (or “right”) designation is not limited to being strictly on the left (or on the right) because the location of an arm read from a fragment can be reported with respect to various reference points such as an observer's orientation, a directionality (e.g., 5′-end to 3′-end, or vice versa) of a DNA strand, or the genome coordinate system that is chosen for a reference genome. A read may be stored with various information, for example, a unique read identifier, an identifier of the fragment, and a mate-pair identifier for reads that are part of mate pairs. “DNB” refers to the sequence of a nucleic acid fragment from which one or more reads (e.g., such as a mated read) have been sequenced. A DNB can be represented by a mated read having a gap between arm reads.

“Mapping” refers to data that associates an arm read (or a mate pair) with zero, one, or more locations in a reference, e.g., by matching an instantiated arm read or mate pair to one or more keys within an index corresponding to a location within a reference. For example, a mapping may associate an identifier of a read with an identifier of a reference locus.

“Allele fraction” refers to the percentage(s) of one or more alleles, for a given locus in a genome, that are sequenced from the nucleic acid fragments included in a biological sample. With some exceptions (e.g., such as the Y chromosome in human males), diploid organisms such as humans typically have two copies of each chromosome. Thus, normally a locus in a genome can be either homozygous (e.g., having the same allele on both chromosome copies) or a heterozygous (e.g., having differing alleles on the two chromosome copies). Hence, an “equal allele fraction” value refers to a data value of 1.0 (e.g., 100% allele fraction for the alleles at a homozygous locus) or 0.5 (e.g., 50% allele fraction for the alleles at a heterozygous locus).

“Variable allele fraction” refers to a data value that is greater than zero but is different than 0.5 and 1.0. Variable allele fraction values can be used to address circumstances in which the alleles for a given locus may be represented in the nucleic acid fragments of a biological sample at fractions that are different than 0%, 50%, and 100%. Such circumstances may include, but are not limited to heterogeneity, contamination, and aneuploidy. For example, a tumor sample (e.g., a cancer sample) may be heterogeneous because of normal/stromal tissue contamination within the sample or because of multiple different tumor populations within the same tumor sample. In another example, a tumor sample may be aneuploid such that a chromosome (or a region thereof) has a copy number different than two, thereby causing an allele fraction to deviate from 50% for a het to 33% or 66% when three copies are present. Examples of variable allele fraction values include, but are not limited to values in the following ranges and/or combination of ranges: 0.005 to 0.10; 0.10 to 0.20; 0.20 to 0.30; 0.30 to 0.40; 0.40 to 0.49; 0.51 to 0.60; 0.60 to 0.70; 0.70 to 0.80; 0.80 to 0.90; 0.90 to 0.99; and more generally any values in the ranges 0.005 to 0.49 and 0.51 to 0.99.

“Hypothesis” refers to a set of one or more alleles that can possibly be present in a genome region that may comprise one or more loci. A hypothesis is typically diploid and includes two alleles; however, in some instances a hypothesis may include only one allele (e.g., for a region in the Y chromosome in human males) or more than two alleles (e.g., such as triploid or higher hypotheses that may be used in some embodiments). “Reference hypothesis” refers to a hypothesis that includes allele(s) from a reference genome for a given genome region. “Homozygous hypothesis” refers to a hypothesis that includes the same allele for the same corresponding genome region in both copies of a given chromosome. “Heterozygous hypothesis” refers to a hypothesis that includes two different alleles for the same corresponding genome region in the two copies of a given chromosome. “Triploid hypothesis” refers to a hypothesis that includes three or more different alleles for the same corresponding genome region in a given chromosome.

A “variant” (also referred to as a “variation”) refers to an allele at a given locus in a biological sample sequence that differs by one or more bases from the allele located at the corresponding locus in a reference sequence. A “small variant” (also referred to as a “small variation”) refers to a variant that comprises one to several tens of nucleotide bases; for example, small variants may be in the ranges of: 1-10 base-pairs (or bps), 1-20 bps, 1-30 bps, 1-40 bps, 1-50 bps, 1-60 bps, 1-70 bps, 1-80 bps, 1-90 bps, 1-100 bps, 1-110 bps, 1-120 bps, 1-130 bps, 1-140 bps, 1-150 bps, 1-160 bps, 1-170 bps, 1-180 bps, 1-190 bps, 1-200 bps, 1-300 and more generally in any sub-range of the range of 1-300 bps, or larger. Examples of different types of variants include, but are not limited to, SNPs, indels, copy number variants (“CNVs”), structural variants (“SVs”), etc. A “reference call” is a determination from a set of reads that a locus is homozygous and equals the reference.

“Score” refers to a value that quantitatively characterizes, for example, a hypothesis, allele, variant, etc. A score may be measured in decibels (dB) and may be based on a logarithmic scale for expressing probabilities, likelihoods, and likelihood-ratios. For example, the value of a likelihood-ratio between two probabilities P₁ and P₂ (e.g., R=P₁/P₂) expressed in dB is 10*log₁₀ R. In cases where decibels are used to encode an error probability P(e.g., as in a basecall quality score or a mis-mapping probability), the score may be expressed as (−10)*log₁₀ P.

“Logic” refers to a set of instructions which, when executed by one or more processors (e.g., CPUs) of one or more computing devices, are operable to perform one or more functionalities and/or to return data in the form of one or more results or data that is used by other logic elements. In various embodiments and implementations, any given logic may be implemented as one or more software components that are executable by one or more processors (e.g., CPUs), as one or more hardware components such as Application-Specific Integrated Circuits (ASICs) and/or Field-Programmable Gate Arrays (FPGAs), or as any combination of one or more software components and one or more hardware components. The software component(s) of any particular logic may be implemented, without limitation, as a standalone or client-server software application, as one or more software modules, as one or more libraries of functions, and as one or more static and/or dynamically-linked libraries. During execution, the instructions of any particular logic may be embodied as one or more computer processes, threads, fibers, and any other suitable run-time entities that can be instantiated in the hardware of one or more computing devices and can be allocated computing resources such as memory, CPU time, storage space, and network bandwidth.

### DETAILED DESCRIPTION

Cancer samples are complex. For example, different cells of a tumor sample can have different genomes. These samples often exhibit such heterogeneity in the genomes due to contamination with normal DNA and/or multiple branches in the tumor evolution. When such different cells are analyzed within a same sequencing experiment, the measured copy number of the alleles at a particular locus can vary. For example, the percentage (allele fraction) of DNA having a particular allele could have any value between 0% and 100%. Thus, a significant challenge in studying cancer genomes is being able to detect variants present in a small fraction of the cells in a cancer sample.

To address this challenge, the process for determining the genome of the sample in a particular region can explicitly allow for the allele fraction to vary between a range of values (e.g., any value between 0% and 100%). This determined genome of the sample can effectively be a composite of the genomes of the various cells within the sample being tested. Accordingly, a more complete picture of the genomic makeup of a tumor sample can be determined using embodiments.

To determine this composite genome, a sequence hypothesis for a region (i.e. a hypothesis for the composite genome in the region) can include a specific variable fraction for the plurality of alleles that comprise the sequence hypothesis. A likelihood of each sequence hypothesis for the variant region can be determined using a probability function that accounts for the fraction of the alleles specified in the respective sequence hypothesis. For example, a particular allele at a particular locus may be present in 20% of the DNA material of the sample, and not present in the remaining 80% of the DNA material of the sample. The probability function can receive the allele fraction(s) as input, and thus hypotheses with different allele fractions would have different likelihoods. Thus, embodiments of a VAF (variable allele fraction) model described herein can assign scores that reflect this possibility of having alleles that are not homozygous (chromosomes are the same) or heterozygous (equal percentage of the two different alleles). In one embodiment, the allele fraction can be required to be above a threshold, e.g., to avoid counting sequencing errors.

### I. Pipeline

When a biological sample is obtained from an organism (e.g., a human), the nucleic acids in the sample can be sequenced to determine a genome of the sample. Typically, part of constructing the sample genome involves mapping (aligning) the sequences to a reference genome and identifying variations between the sequences and the reference. However, the process of determining a sequence is not error-free. Thus, determining whether the sequencing data actually indicates a true variant or not can be difficult. This difficulty can be compounded when the sample is actually a composite of various cells, with differences in their genomes. The following pipeline provides various embodiments of methods that can be used to identify variations in the genomes of only some of the cells in the sample and determine a fraction of the cells in which a variant appears. The pipelines can also be used to determine a likelihood of whether somatic variations in a tumor sample relative to a normal genome of the organism are true variations.

A. System

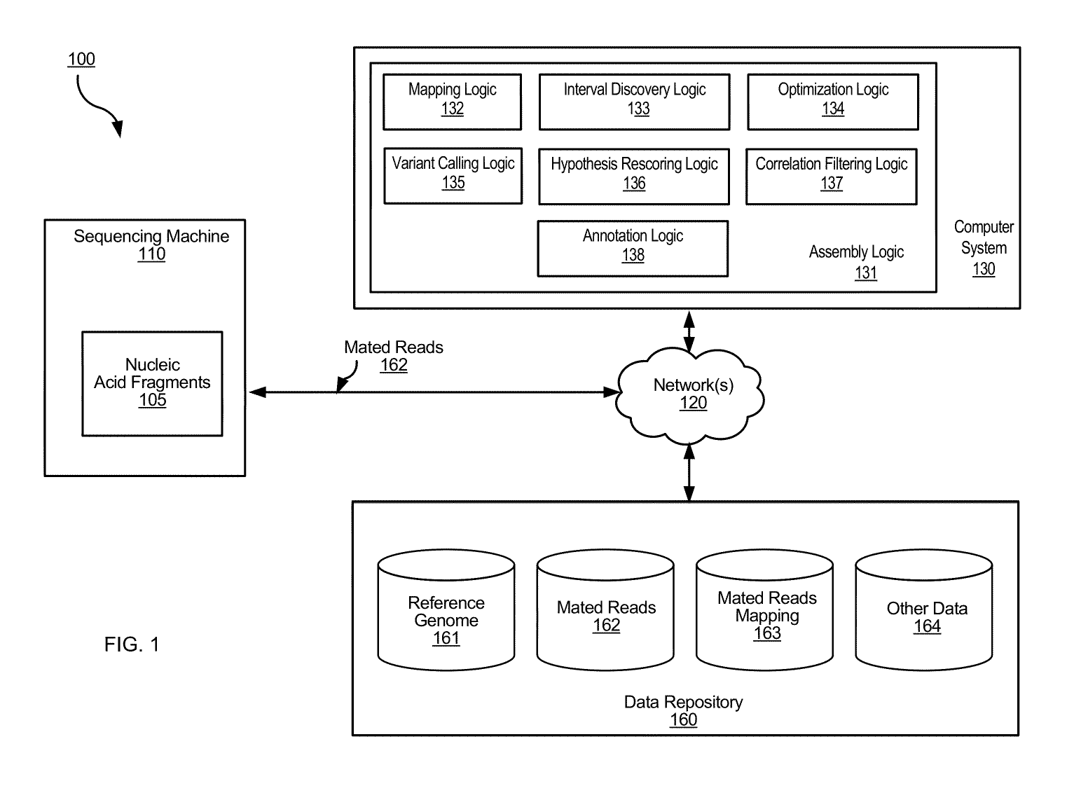

FIG. 1 is a block diagram of an example system 100 that is configured to perform techniques for calling variants according to embodiments of the present invention. In some embodiments, system 100, or specific subsystems thereof, can be used in any of the methods and techniques described herein. System 100 can include multiple subsystems such as, for example, one or more sequencing machines such as sequencing machine 110, one or more computer systems such as computer system 130, and one or more data repositories such as data repository 160. The various subsystems may be communicatively connected over one or more networks 120, which may include packet-switching or other types of network infrastructure devices (e.g., routers, switches, etc.) that are configured to facilitate information exchange between remote systems. Certain aspects of implementation of system 100 are described in U.S. patent application Ser. No. 12/770,089, the entire contents of which are hereby incorporated by reference as if fully set forth herein.

Sequencing machine 110 is configured and operable to receive nucleic acid fragments 105 derived from molecules in a biological sample, and to perform sequencing on the fragments. Any suitable machine that can perform sequencing may be used. In some embodiments, the sequencing of the fragments may result in reads that do not include gaps. In other embodiments (such as the embodiment illustrated in FIG. 1), the sequencing of the target nucleic acids may result in obtaining mated reads 162, which are transmitted for persistent storage to data repository 160. Mated reads 162 include two arm reads from different ends of a fragment.

Data repository 160 may be implemented on one or more storage devices (e.g., hard-disk drives, optical disks, solid-state drives, etc.) that may be interconnected in a suitable manner such as, for example, a grid, a storage cluster, a storage area network (SAN), and/or a network attached storage (NAS). In various embodiments, data repository 160 may be implemented on the storage devices as one or more file systems that store information as files, as one or more databases that store information in data records, and/or as any other suitable storage organization. In the embodiment shown, data repository 160 is configured to store the sequences for a reference genome 161, mated reads 162, and the mappings 163 of the mated reads to reference genome 161. Data repository 160 is also configured to store various other data 164 including, but not limited to, hypothesis data, variant scoring data, calibration data, and various other intermediate data and/or final results (e.g., such as variant files) that are generated by the various computer logics in computer system 130.

Computer system 130 may include one or more computing devices that comprise general purpose processors (e.g., Central Processing Units, or CPUs), memory, and logic which along with configuration data or software can perform the techniques described herein. In some embodiments, computer system 330 may be a single computing device. In other embodiments, a computer system may comprise multiple computing devices that may be communicatively and/or operatively interconnected in a grid or a cluster; such multiple computing devices may be configured in different form factors such as computing nodes, blades, or any other suitable hardware configuration.

In the embodiment shown, computer system 130 comprises assembly logic 131 (also referred to as “assembler”) that is configured to perform the techniques for calling variants described herein. Mapping logic 132 is configured to map mated reads 162 to reference genome 161 and to generate and store mappings 163. Interval discovery logic 133 is configured to determine (e.g., based at least on mated reads 162 and mappings 163) variation intervals (also called variation regions) in the sample genome of a biological sample that can plausibly contain variants (including small variants). Optimization logic 134 is configured to search the space of hypotheses to find optimal hypotheses based on probability scores, e.g., to determine a maximum likelihood hypothesis or hypotheses for each variation interval. Variant calling logic 135 is configured to call variants and to assign variant scores indicating a likelihood of the variant hypothesis based on the optimal hypothesis(es).

Hypothesis rescoring logic 136 is configured to re-score the hypothesis of the variant (potentially changing the variant score). Correlation filtering logic 137 is configured to determine segmental duplications and to no-call variants in the corresponding genome regions. Annotation logic 137 is configured to annotate the called variants with information from various genome databases, and to store the annotations in variant file(s) or other suitable storage structure(s). The functionalities of logic 132, 133, 134, 135, 136, 137, and 138 may be implemented in the same integrated module (e.g., in an integrated assembly logic) or may be combined in two or more modules that may provide some additional functionalities.

B. Method

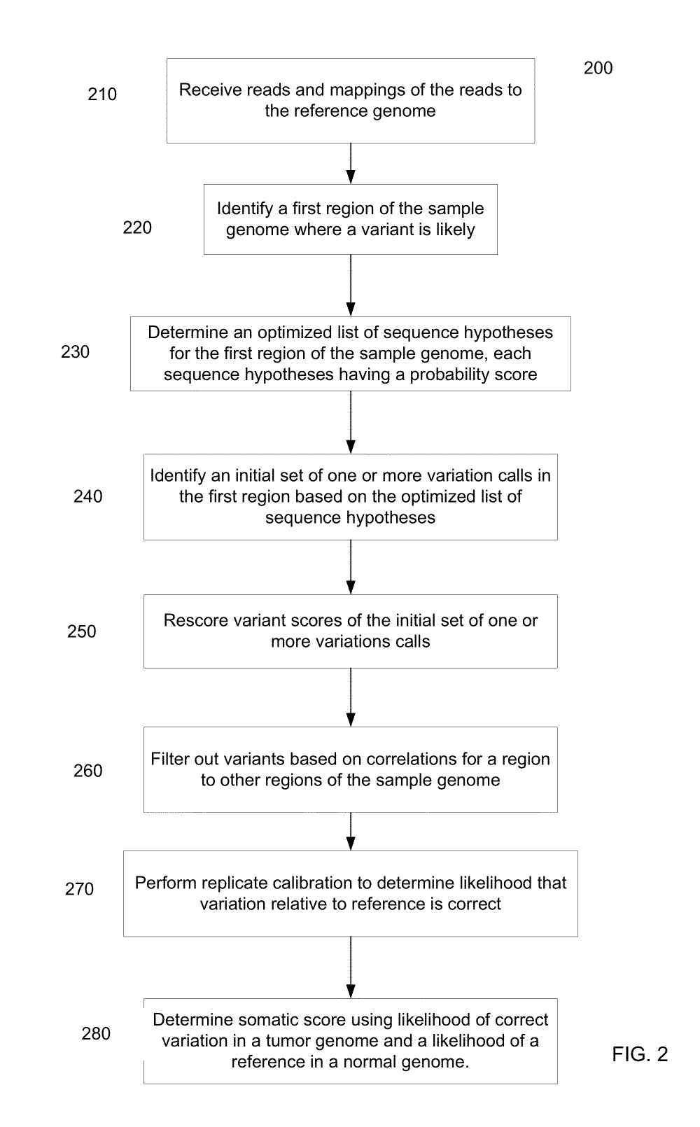

FIG. 2 is a flowchart of a method 200 for determining one or more variants between a reference genome and a sample genome of a biological sample from a diploid organism according to embodiments of the present invention. Method 200 may be performed by system 100. As with other methods, various steps may be performed in a different order than presented.

At block 210, reads of the sample genome and mappings of the reads to the reference genome are received. The reads may be received from sequencing machine 110 that sequences a plurality of genomic fragments from the biological sample. The reads (e.g., mated reads 162) can be sent to a computer system 130 for analysis. The mapping of a read to a reference genome may be exact or have mismatches (e.g., less than a threshold, such two). For some mate pairs, only one arm read of a mate pair matches.

In one embodiment, for each arm of a mate pair, mapping logic 132 can find all perfect matches and all 1-discordance (k=1) matches, find a substantial fraction of the one-arm matches up to k=5, and find all k=2 matches. Mappings that are within a few bases of each other may be de-duplicated. For example, clonal DNBs may not be independently generated, but each contributes independently to the score. Duplicate DNBs can be removed by sequence similarity. Arm reads with too many index hits or too many matches after the local de-duplication may be marked as “overflow”, and the mappings of the arm reads omitted. Reads that include duplicated genomic positions can be filtered out.

At block 220, a first region of the sample genome is identified, where the first region has a first likelihood of including one or more variants relative to a corresponding region in the reference genome that is above a first threshold. For example, if a specific locus had allele A in the reference genome and a significant fraction (i.e. greater than a threshold) of allele G showed up in reads that mapped to the specific locus, then a region that includes the specific locus can be identified. As another example, a probability function can be used to test whether there is a sufficient likelihood (i.e. a probability greater than a threshold) of one or more other alleles at any fraction. A plurality of such variation regions can be identified, and some may be combined to create larger regions (e.g., when two regions are close to each other).

Thus, interval discovery logic 133 can scan the sample genome represented by the reads, looking for regions of the genome that may plausibly contain SNPs or short indels. The results can provide (1) a set of variation intervals (also referred to as variation regions) that are investigated in more detail in an optimization stage and (2) the reference scores, which give an indication of the likelihood that a variant exists at any given base. In one embodiment, interval discovery logic 133 can try a hypothesis of each one-base SNP.

Interval discovery logic 133 can also run local de novo assembly logic to find indels. At each position of the reference where local de novo logic indicates even slight evidence of an indel existing, interval discovery logic 133 can try all one-base indels. Interval discovery logic 133 may also try all single-copy insertions or deletions in low-complexity regions (e.g., homopolymer runs, dinucleotide runs, and other low-complexity sequence of recurrence period up to 10). Interval discovery logic 133 may additionally try all known indels and short block substitutions, taken from one or more databases of variants such as, for example, a proprietary variant databases and/or publicly available databases such as dbSNP.

At block 230, an optimized list of sequence hypotheses for the first region of the sample genome is determined. In one embodiment, optimization logic 134 can received any of the results of local de novo assembly, a set of known indels and block substitutions, and the reference as input for an initial seed (starting hypothesis) for the optimization. Optimization logic 134 can use the starting hypothesis to generate new hypotheses in a greedy optimization procedure, which looks for the maximum likelihood hypothesis.

Each sequence hypothesis has a probability score, which is used to determine the optimized list. A single sequence hypothesis can include one or more sequences corresponding to the first region. For example, one hypothesis may be that the first region is homozygous for the same 7 nt, which effectively identifies two identical sequences for the sample genome in the first region. This hypothesis would have one probability score (e.g., as determined using a Bayesian framework and the mapping information). Another hypothesis for the first region may be that the third position in the first region is heterozygous for two alleles (e.g., A and G). The hypothesis would then be two different sequences that differ at the third position. Yet another hypothesis may be that allele A is present 80% and allele G is present 20%, which could occur if 60% of the cells in the sample are homozygous for A and 40% are heterozygous for A/G. The calculation would be as follows 0.6+0.4*0.5=0.8 (i.e. 80%) and 0.4*0.5=0.2 (i.e. 20%). The concept of an allele fraction is discussed in more detail below.

Sometimes only one hypothesis has an appreciable probability score (e.g., being above a threshold). Other times, several probabilities may be relatively close (even large dB difference can be considered close). In such instances, further analysis may be needed. Having several hypotheses close in probability score typically would occur when the variation is more than one base, e.g., 10 or 20 bases. In such a complex variation, multiple hypotheses might have similar probability. In either case, the top hypothesis, the top hypotheses, or all hypotheses and their respective probability scores can be provided to a variant caller for resolving.

At block 240, an initial set of one or more variation calls in the first region is identified based on the optimized list of sequence hypotheses. If only one hypothesis as an appreciable probability, then that top hypothesis may simply be chosen. In this case, if the top hypothesis differed from the reference, then a variant can be called. However, when multiple hypothesis are relatively close (e.g., 100 dB) more complex analysis may be performed.

Variant calling logic 135 can determine the most likely hypothesis from the optimized list of scored hypotheses generated during the optimization stage to either call variations or make no-calls. For example, a relative value (variant score) of the probability scores of the top hypotheses can be used to determine a variant score that is indicative of a reliability of the top hypothesis being more likely correct than the next highest hypothesis. In one embodiment, if the variant score is above a threshold, then a variant call is made. If the variant score is below the threshold, no-call can be made; the hypotheses and their probability scores can be passed to further stages as a re-scoring could change the call or simply be output for analysis. Thus, the variant caller stores and/or outputs, in suitable persistent or temporary data structures, an initial set of calls along with their corresponding variant scores and next-best hypotheses.

At block 250, the variant scores of the initial set of one or more variations calls can be rescored. For example, a contribution of one read to a variant score can be limited. In this manner, a reduction in false positive rate can be achieved by ensuring that individual reads cannot provide overwhelming support for a hypothesis.

At block 260, certain variants can be filtered out based on correlations of a region (e.g., the first region) to other regions of the sample genome. Correlation filtering logic 137 can identify regions where the probability scores of the hypotheses are likely to be unreliable due to sequence similarity with other regions of the genome. Correlation filtering logic 237 can change the variant calls into no-calls to reduce the false positive rate of variant detection in repetitive regions. For example, the logic within previous assembly stages considers each region of the genome in isolation, and assumes the rest of the genome is equal to the reference. As a result, within segmental duplications and other regions of large-scale similarity where the reads cannot be uniquely mapped, the variant caller may call variants in all the regions of similarity that should have only been called for one region. Because the reads cannot discern which region of the genome these variants truly exist, such duplicative regions can be no-called.

At block 270, a calibration score is determined using replicate calibration. The confidence scores from block 250 may not be accurate for determining whether a variant actually exists. The scores reflect which hypothesis is more likely given the data, but due to errors in the data, the hypothesis might actually be incorrect. Replicate scoring provides a way to create a score of how likely a variant actually exists. A reference calibrated score can also be determined to measure a likelihood that a reference call is a false negative. These calibration scores can be determined by comparing genomes determined from the same sample, and analyzing discordant loci where one genome has a variant and the second genome has a reference call.

At block 280, somatic score can be determined for a locus where a variant occurs in a tumor sample, but not in a normal sample. Such discordant loci can be determined by performing sequencing runs on the tumor sample to determine first variants in the tumor genome and performing sequencing runs on the tumor sample to determine second variants in the normal genome. Then, a variant score for the tumor genome can be used to determine a likelihood of a false positive and a reference score of the normal genome can be used to determine a likelihood of a false negative (e.g., using the calibrated scores in block 270), which can be combined to determine a likelihood of whether the somatic mutation is true or not.

C. Interval Discovery

In various embodiments, the interval discovery process may comprise trying a hypothesis for one or more of: (1) all possible one base variations for SNPs for any allele fraction; (2) all possible one base insertions and deletions where local de novo assembly indicates even slight evidence of an indel existing in homozygous and heterozygous form; (3) all single-copy insertions or deletions in a tandem repeat period up to 10 bases in homozygous and heterozygous form where local de novo assembly yields evidence for indel; (4) known indels and short block substitutions taken from one or more databases of known variants; and/or (5) short indels (of several nucleotides) discovered by a fast version of the local de novo assembly.

For each hypothesis G, logic can compute the likelihood L(G) of that hypothesis being correct. At most locations, L(G) is computed to be negative, indicating that the reference is more likely than any other variations at that position. Where a one-base variation is present, L(G) is computed to be large and positive. In regions harboring longer variations, L(G) for one-base variations is usually still negative, but to a much lesser degree than in regions where no variation is present. In this event, L(G) can be used to indicate the presence of a nearby variation and such variant regions can marked for optimization in the subsequent stage. In one embodiment, the logic may no-call intervals that are longer than 200 bases without attempting optimization, as optimization may become too computationally intensive.

When all possible one base variations for SNPs are scanned, a probability score can be computed for each position in the genome to give an indication of the likelihood that a variant exists at any given base. A probability score greater than a threshold (e.g., 10 dB) can mark the interval for optimization in the optimization stage. The variant region can be larger than just the one base, e.g., a window centered around the SNP, such as a 7-base window.

For variants a little larger than one or two bases (e.g., 10 bases), a graph version of local de novo assembly may be used. A quick version may be used by identifying when a few branches (e.g., greater than some threshold) in the graph that are different than the reference appear, and then simply identifying those regions as possibly containing a variation. A threshold for determining a variant region can also be the number of mate pairs that support a particular branch or based on the number. Such use may occur when some reads are partially mapped to the region, but begin to differ once the read enters the variation. The overlap of the unmapped reads can be used to determine a starting hypothesis in a variant region for the optimization.

For larger variations (e.g., greater than 20 bases), there may not be any reads that map to the region of the actual variation. Such regions can be identified by looking at changes in coverage of a region, which may indicate an indel or a rearrangement. Once a region is identified, local de novo can look at mate pairs where one arm read maps near the region (e.g., within 500 bases). The other arm reads can then be analyzed to identify consistencies between these other arm reads. These other arm reads may not map to anywhere on the reference genome (at least not within an expected range of the mapped arm read). Such a mate pair can be called a discordant mate pair. The consistencies between the unmapped arm reads can be determined using de Brujin graphs as mentioned herein and described in U.S. patent application Ser. No. 12/770,089.

D. Optimization

In various embodiments, the optimization procedure can be seeded by the most likely hypothesis, out of the following hypotheses: the reference hypothesis; the set of hypotheses discovered as plausible hypotheses by using a local de novo assembly; the set of hypotheses in the set of indels and block substitutions assembled in one or more databases of known variants, which could be known from sequencing a genome of parents, siblings, or other family; a single read, when the entire read covers the variant region; and a normal genome for a seed for a tumor sample. Using known variants can increase insertion sensitivity and reduce false negatives (e.g., indels called as reference), especially for indels and SNPs near other variants.

This starting hypothesis can serve as input into an optimization procedure (e.g., a greedy optimization procedure), which searches for the most likely combination of alleles to identify the maximum likelihood (or top) hypothesis. In one embodiment, at each iteration of the optimization, the logic evaluates the likelihood (probability score) of each hypothesis that is generated by deviating from the starting hypothesis by a single-allele variation corresponding to a single SNP, one base indel, or insertion or deletion that adds or subtracts a single copy of a simple repeat, such as homopolymer and dinucleotide run. The group of hypotheses for an iteration may be generated in other ways as well.

At each subsequent iteration, the computer logic takes as input the best (top) hypothesis discovered during the previous iteration. In one implementation, a probability score is determined via a Bayesian framework (described below) to compute the likelihood of the hypothesis. When an iteration of the optimization is unable to find a more likely hypothesis, the computer logic has converged at a local minimum and the optimization completes. This approach allows discovery of both isolated variations as well as any combinations of multiple SNPs and indels within an interval, and overlapping distinct variations on opposite haplotypes. For each interval, the optimization logic can store and/or output, in suitable persistent or temporary data structures, a list of the most likely hypotheses which are used as input into the next (variation calling) stage where variations are called based on these values.

As an example, if a particular hypothesis in a group (e.g., a group generated during an iteration) has a better score than the starting hypothesis, then the logic can select this particular hypothesis as a new starting hypotheses for a next iteration. The logic can use the new starting hypothesis to generate a new group of hypotheses for the region and score each hypothesis in the new group of hypotheses. The computer logic may repeat this process one or more times until the current starting hypothesis has a better score that any hypothesis in the current group of hypotheses.

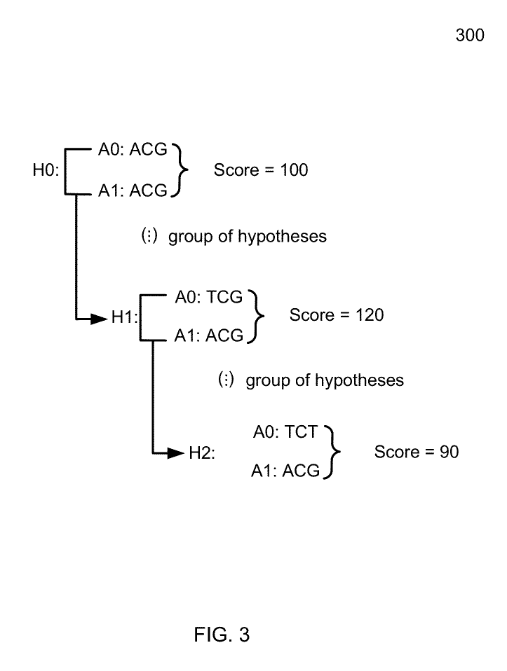

FIG. 3 shows an example process 300 for selecting new starting hypotheses according to embodiments of the present invention. The process starts with hypothesis “H0” as the starting (or seed) hypothesis (which includes two alleles—“ACG” and “ACG”), and a score of “100” is computed for this hypothesis. Based on hypothesis “H0”, a computer logic generates a group of hypotheses and scores each hypothesis in the group; then, the computer logic determines that one particular hypothesis in the group, hypothesis “H1” (which includes two alleles—“TCG” and “ACG”) has a better score (“120”) than hypothesis “H0”. The computer logic then sets hypothesis “H1” as the new starting hypothesis, generates a new group of hypothesis based on the new starting hypothesis, and scores each of the hypotheses in the new group. By comparing the computed scores, the computer logic determines that the best-scoring hypothesis in the new group, hypothesis “H2” (which includes two alleles—“TCT” and “ACG”), has a lower score than the new starting hypothesis “H1”; thus, the computer logic selects hypothesis “H1” as the top hypothesis for the variant region and terminates the scoring process

E. Variation Calling

Various embodiments of variation calling are now described. Variant caller logic can be configured to turn the scored hypotheses from the optimization stage into scored variant calls and no-calls. Thus, the variant caller can determine where to make a call, where to no-call, how to align calls to the sample genome, what variant score to give each variant call, and how to assign haplotype identifiers to variant calls. A haplotype ID identifies a chromosome copy such that if two alleles have the same haplotype ID (e.g., a “0” or “1”), it would mean that the two alleles are present in the same copy of a given chromosome. In one embodiment, the variant caller logic uses a Bayesian model to compute a probability ratio for any two hypotheses from the optimization stage, and variant calls are then made based on the most likely hypothesis according to this Bayesian probability model.

The variant caller can begin by aligning the top hypothesis to the genome using a simple sequence aligner with affine gap costs. Gaps in the alignment represent indels. Gaps (indels) that are not near other variants can be forced to the left, into canonical form. Indels that are within two bases of another variant are left near the other variant, as these are turned into a block substitution call. In one aspect, all calls eventually made will be consistent with this alignment of the top hypothesis.

Based on the alignment of the top hypothesis, the variant caller logic can determine the initial set of calls and call boundaries. For example, if there's a SNP, a reference base, and a SNP on the same allele, it can be considered a single call of a three-base substitution. But if the hypothesis has a SNP, two reference bases, and a SNP, then it can be considered two separate SNP calls, and one reference call between them. Thus, in one embodiment, any two contiguous reference base calls split up a call into two separate variant calls and one reference call. Once the logic has determined the call boundaries for each allele, the logic can then determine locus boundaries. To determine the locus boundaries, the logic can split the variation interval into initial variant loci defined by the following rules: calls that overlap by at least one reference base are merged into a single locus; and calls that have 0 reference bases (e.g., insertions) are merged with any adjacent locus.

Once the variation interval is split into variant loci, the variant caller logic coerces the loci to the appropriate ploidy. For triploid hypotheses (discussed in more detail below), each locus is separately coerced into a diploid hypothesis. Most triploid hypotheses can be coerced into diploid variant loci since there are typically only two distinct alleles at each locus. It is noted, however, that upon coercion of a triploid hypothesis into diploid loci, some phasing information may be lost. Also, variant loci with three alleles may be no-called. For variant loci with three alleles, a no-call must be made. In practice, most triploid hypotheses can be coerced into diploid variant loci, because at each locus, there are only two distinct alleles. When a triploid hypothesis is coerced into diploid loci, some haplotype ID information is lost.

For each additional hypothesis within 10 dB of the top hypothesis, the variant caller logic aligns the hypothesis to the reference using the same rules as for the top hypothesis, except that gaps may be preferentially placed at the same position as variants in the top hypothesis. For each such hypothesis alignment, the variant caller logic compares the aligned bases to the top hypothesis. At any position of discrepancy, the variant caller logic may need to make a no-call.

The variant caller logic calculates initial variant scores for each call as the logarithm of probability ratio (decibel separation, dB) of the most likely hypothesis compared to the next best homozygous hypothesis not containing a given candidate variation (i.e. conflicting hypotheses). If the variant score for a given variation exceeds a threshold (e.g., such as 10 dB and 20 dB for homozygous and heterozygous variations, respectively), the variant caller logic calls the variation along its variant score. If the variant score is below the threshold, the variant caller logic reports a “no-call” for the corresponding portion of the reference.

For heterozygous calls, the variant score is the difference between the top hypothesis score and the score of the first hypothesis that is homozygous at the position of the call, but discordant with the call. Thus, the score is more indicative of the existence of the call than the correctness of the call. This definition can be illustrated by the following example:

Top Hypothesis (score 100):
ACAG-AAAAAAAATGC
ACAGAAAAAAAAATGC
Next Hypothesis (score 30):
ACAG--AAAAAAATGC
ACAGAAAAAAAAATGC
Reference Hypothesis (score 0):
ACAGAAAAAAAAATGC
ACAGAAAAAAAAATGC

In this example, the variant caller will call a heterozygous one-base deletion (marked as “-” in 5^{th} position) with score 100, rather than 70. The reason is that although there are 70 dB of support for the one-base deletion with respect to the two-base deletion, there are 100 dB of support for a non-reference variant. This way of defining the score yields an improved ROC (Receiver Operating Characteristic) curve for somatic events where the germline sequence is reference, but the ROC curve for mismatching events is worse. The worse ROC curve for mismatching events can be mitigated by setting a threshold (e.g., 20 dB) on the score to the next best hypothesis. Based on calibration results, variants called at 20 dB may be ten times (10×) as likely to be false than true.

For homozygous calls, the variant score is the difference between the top hypothesis score and the first hypothesis that is discordant with the call, and the variant score of the other call is determined using the same rules as for a heterozygous call. In this way, the call with the lower score indicates that no other allele exists at this locus and the call with the higher score indicates that this allele exists at this locus. When the variant caller logic applies the variant score to the call, the variant caller logic records the next best hypothesis that was used to determine the variant score, since this hypothesis can be re-scored in the hypothesis rescoring stage.

Similarly, the reference score is the likelihood of the reference divided by the likelihood of the best non-reference hypothesis, e.g., as expressed in decibels. Thus, a reference score of 10 means that reference is 10× as likely as any other hypothesis, a score of 20 means reference is 100× as likely as any other hypothesis, and a score of 30 means reference is 1000× as likely as any other hypothesis. A reference score of −10 means some other hypothesis is 10× as likely as reference.

F. Correlation Filtering

As mentioned above, the correlation filtering logic can change a variant call to a no-call in a region that is similar to other regions, thereby substantially reducing false positive calls in repetitive regions. For example, in some cases two regions at a time need to be considered due to mate pairs having good mappings to both regions.

Based on the stored information, the variant caller can compute a likelihood of a sequence hypothesis G as a logarithmic likelihood ratio L(G), where L(G)=log (Pᵥ/P_{Ref}). Pᵥ is a probability of a 1-base initial hypothesis, and P_{ref} is a probability of the base value in the reference G₀. The set of mapped mated reads near each base position can be used during calculation of the probability ratio at each base position.

The above formulation is used to compute L(G) for a genome G which differs from G₀ only in a single small area, called the active interval. In that case, computing L(G) gives information regarding the likelihood of a given variation in the active interval, under the assumption that G and G₀ are identical outside the active interval. However, it is also useful to consider at the same time the possible presence of variations in two separate regions of the genome, A and B, potentially far away from each other. Specifically, if the two regions are separated by a sufficiently large distance, it is impossible for specific polynucleotide sequence (such as those generated with certain empirical operations) to have a mapping that covers both regions, even partially. Consider the two regions, 1 and 2, in the following genomes:

Genome G₁, which differs from the reference in region 1 but is identical to the reference in region 2.
Genome G₂, which differs from the reference in region 2 but is identical to the reference in region 1
Genome G₁₂, which differs from the reference in both regions, and which is identical to G₁ in region 1 and identical to G₂ in region 2.

In most cases, the equality L(G₁₂)=L(G₁)+L(G₂) will hold (i.e., the two intervals are uncorrelated) since the set of arm reads supporting G₁ is disjoint from the set of arm reads supporting G₂. However, there are situations where the two sets of supporting arm reads are not disjoint, for example:

The two active regions are less than≈40 bases, such that a single DNB arm can overlap both.
The two active regions are at a distance approximately equal to a mate gap length such that a single DNB can overlap both.
The two active regions are at any distance from each other in the genome but are similar in sequence (exactly or approximately), and a DNB can have good mappings to both regions.

In these situations, a correlation term appears and L(G₁₂) no longer equals the sum of L(G₁) and L(G₂), but instead L(G₁₂)=L(G₁)+L(G₂)+C₁₂, where C₁₂ is the correlation term. C₁₂ can be computed using information stored during the optimization stage, and therefore L(G₁₂) can be computed for each pair of called variants. L(G₁₂) can then be compared with both L(G₁) and L(G₂).

The value of the correlation term can reveal information that contradicts the conclusions one would have reached by considering L(G₁) and L(G₂) in isolation. For example, in a pair of regions with high sequence similarity, one can have large, approximately equal values L(G₁)=L(G₂)=L(G₁₂). In this example, all three of the following hypotheses are equally likely: the variant exists in region 1 and not region 2; the variant exists in region 2 and not region 1; and the variant exists in both regions. Thus, for each of the two possible variants, there are conflicting hypotheses with equal likelihood, one hypothesis indicating the variant exists and the other indicating the variant does not exist. For this reason, the computer logic at the correlation filtering stage can detect such duplicative regions and to no-call the variants that may have been called (at the previous stages) in such regions.

In one embodiment, if one of these three quantities (L(G₁₂), L(G₁), and L(G₂)) exceeds the other two by more than a predetermined threshold (e.g., 30 dB), then the corresponding hypothesis is called. This could mean that one of the two variants is likely to actually not be in existence, and therefore the corresponding region is called equal to the reference. In some cases, two of the three quantities are too close to confidently make a choice. This could cause some no-called regions to be added to the variant file. For example, if L(G₁₂)=200 dB, L(G₁)=200 dB, L(G₂)=100 dB, both of the two most likely hypotheses contain the variation in region 1, which is therefore still called. However, the variation in region 1 needs to be no-called because G₁₂ and G₁ are equally likely.

### II. EAF Method

In the equal allele fraction (EAF) method, there are three options for the hypothesis at a locus: homozygous for a first allele A (100% A: 0% B), homozygous for a second allele (0% A: 100% B), or heterozygous (50% A: 50% B). These options are the standard options considered when determining a genome. The option that is highest is taken as the hypothesis at the locus. The probability can be computed using a Bayesian Probability Model.

In these embodiments, computer logic computes scores for a sequence hypothesis from a Bayesian probability model that can, for example, takes into account: quantity of evidence (read depth); quality of evidence (base call quality scores); mapping/alignment probabilities (selection of evidence); and empirical priors on gap sizes and discordance rates. Thus, a probability can be based on the errors (quality) of measurement for reads (e.g. image processing errors), consistency of reads to a given hypothesis, and gap probabilities (whether an assumed gap is within an expected range).

In one example, a Bayesian probability model indicates the likelihood of a hypothesis (H) given the set of reads, corresponding to DNBs (an example of molecules from which mate pairs can be obtained), that are present in the raw data:

$$\frac{P ( {H}_{i} \vert DNBs )}{P ( {H}_{j} \vert DNBs )} = \frac{P ( DNBs \vert {H}_{i} ) {P}_{prior} ( {H}_{i} )}{P ( DNBs \vert {H}_{j} ) {P}_{prior} ( {H}_{j} )}$$

Although for a typical human genome substantial priors exist (such as, for any given base position, the hypothesis that a heterozygous SNP exists is only about 1/1000 as likely as the reference sequence), in an example embodiment the assembler uses no prior information about hypothesis likelihood in computing the likelihood ratio. Thus:

$$\frac{P ( {H}_{i} \vert DNBs )}{P ( {H}_{j} \vert DNBs )} = \frac{P ( DNBs \vert {H}_{i} )}{P ( DNBs \vert {H}_{j} )} \\ \frac{P ( {H}_{i} \vert DNBs )}{P ( {H}_{j} \vert DNBs )} = \frac{{\prod }_{DNB ∈ DNBs} P ( DNB \vert {H}_{i} )}{{\prod }_{DNB ∈ DNBs} P ( DNB \vert {H}_{j} )} \qquad ( 1 )$$

In the latter equation (1), it is assumed that all DNBs are independent. However, this assumption is sometimes violated, such as in cases where the DNBs may split apart and be sequenced on several spots on a patterned array, or a single fragment of DNA may be duplicated in the library preparation process and result in multiple DNBs. Thus, DNBs are de-duplicated by sequence similarity before they are used by the small variant assembler.

Once arriving at equation (1) above, evaluating the likelihood ratio of any two hypotheses becomes a matter of determining P(DNB|Hᵢ) for each DNB and hypothesis. Accordingly, in the EAF model, the probability of each of the three possible hypotheses is determined, and the hypothesis with the highest probability can be selected.

### III. Variable Allele and Heterogeneity

As mentioned above, for equal allele fraction (EAF), there are only three possible hypotheses. But, sometimes a sample may not fit into one of the three standard hypotheses for a genome. Such instances are cancer, where each cell of a tumor may not have the same two haplotypes of the diploid genome, but instead different cells of a tumor can have many different variations. Embodiments provide a new model to analyze such instances. Accordingly, a hypothesis can include a percentage (allele fraction) of each allele at a locus and that percentage can be different than 0%, 50%, or 100%.

This variation in the genomes of the cells in cancer tumors is called heterogeneity. Heterogeneity can arise due to multiple tumor populations (tumor genomes in a given sample branch can accumulate different mutations) and normal tissue contamination (tumor samples contain varied levels of actual tumor content). Such varied mutations can also include an aneuploidy (an abnormal number of chromosomes or chromosomal regions).

In some embodiments that rely on short-read sequencing, a biological sample may comprise thousands and even millions of cells from which DNA fragments are extracted and then sequenced. Since different tumor cells can have different DNA sequences (e.g., especially in cancer cells where the DNA changes constantly), a biological sample of tumor cells can actually have a heterogeneous mixture of DNA of different genomes, resulting in a composite genome for the sample genome. Examples of the type of mixtures that can result in tumor samples is now provided.

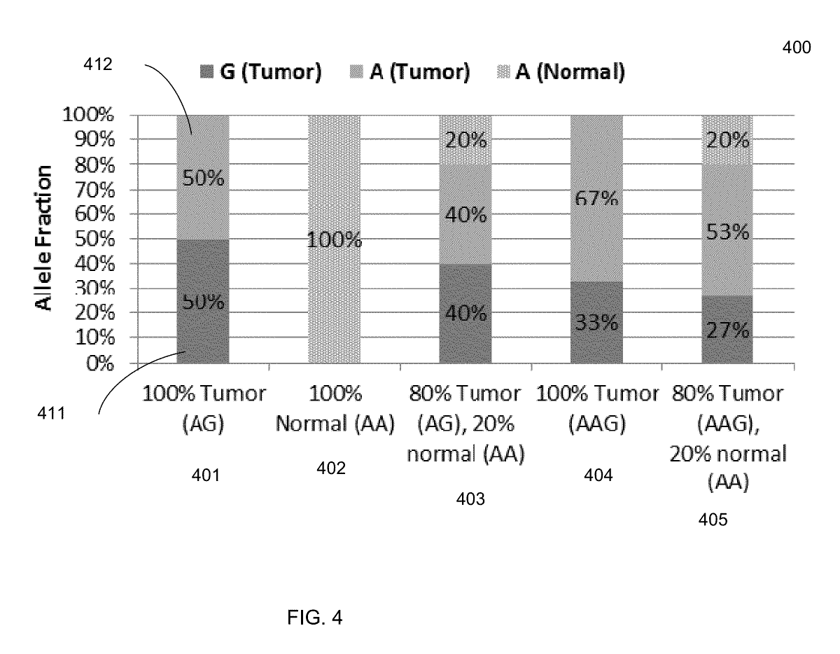

FIG. 4 is a graph 400 illustrating different mixtures of different cells having different genomes. Samples 401-405 exhibit different mixtures of types of cells. Each bar corresponds to a different sample, where the different colors and percentages show the fraction of an alleles G and A at a particular locus. Under each bar shows the percentage of cells from a tumor (and the type of tumor) and the percentage from a normal cell. The vertical axis shows the allele fraction from 0% to 100%. The allele fraction (AF) is the percentage of the sample containing a specific allele at a specific locus.

Sample 401 is 100% tumor I, where tumor I is equally heterozygous for allele A and G. This equal heterozygosity is what is normally considered by the term heterozygous. Allele G is marked in the darker 50% section 411 and allele A is marked in section 412. Sample 402 is 100% normal cells, which are homozygous for A. Sample 403 is 80% tumor 1 and 20% tumor. Thus, sample 403 is 60% allele A and 40% allele G. The contributions to the 60% allele A is shown as being 40% from tumor I cells and 20% from the normal cells. Accordingly, a variant may be at an lower allele fraction than 50% due to having a heterogeneous sample.

Sample 404 is 100% tumor II, where tumor II has 67% allele A and 33% allele G. Such allele fractions can result from an aneuploidy (specifically trisomy) of the chromosome or chromosomal region that includes the locus, or from a duplication of the locus within a chromosome or in another chromosome. Sample 405 is 80% tumor II and 20% normal, which provides 27% allele G and 73% allele A (20% from the normal cells and 53% from tumor II cells). Many other mixtures can exist, including having more than two alleles (e.g., 3) present in the sample at a specified locus.

As one can see, the genome of a sample may be a composite genome of the different cells that make up a mixture that is the sample. The tumor heterogeneity, aneuploidy, and normal tissue contamination makes it more difficult to call variants. Embodiments can determine this composite genome by allowing the allele fraction for any locus to be variable, thereby allowing the detection of percentage of a variation at a particular locus and the percentage of the cells in the sample having a particular variation.

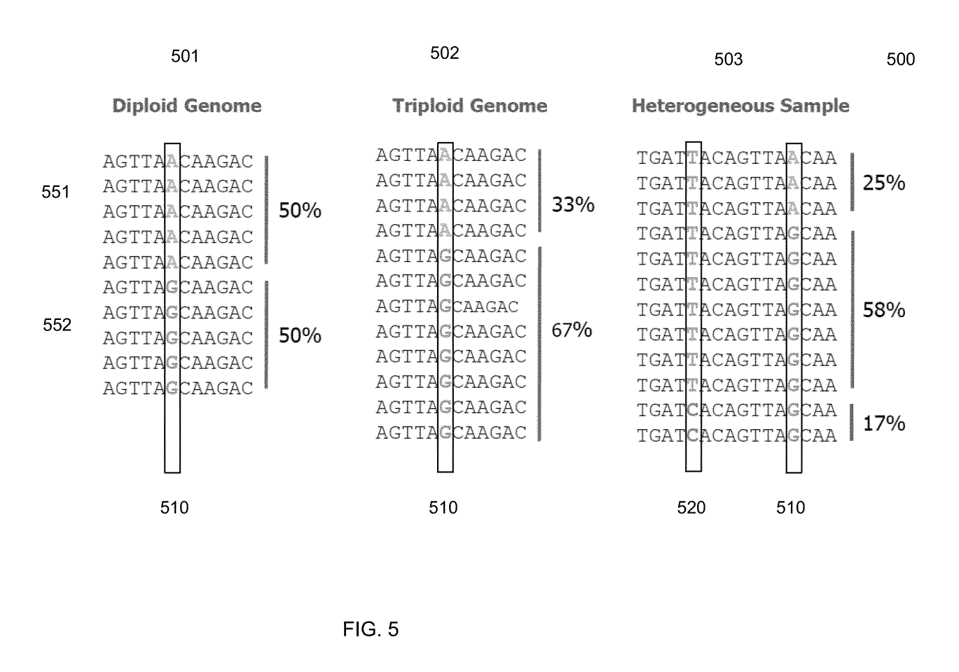

FIG. 5 shows a diagram 500 of the genome of three different sample 501-503. Sample 501 has a diploid genome that is heterozygous at locus 510, which can be or be part of a variant region. In such a diploid genome, allele A at locus 510 would come from haplotype I (e.g., from the mother) and allele G at locus 510 would come from haplotype II (e.g., from the father). The two haplotypes are the same at other positions within the region shown. Such a diploid genome can be determined from one of the three standard hypotheses namely equal heterozygous. Sample 502 has a triploid genome at locus 510. All of the cells in sample 502 are triploid in that there are two copies haplotype II. Thus, there are three chromosome copies per cell in the region shown.

Sample 503 is a heterogeneous sample of different types of cells having different genomes. This tumor region has three distinct alleles with two het SNP loci 510 and 520. The first allele has T at locus 520 and A at locus 510. The second allele has T at locus 520, but G at locus 510. The third allele has C at locus 520 and G at locus 510. Such knowledge of the composite sample genome could be determined from computing that 83% of the genome has T at locus 520 and 25% of the composite sample genome has A at locus 510. The correlation between the two hets can be done by phasing to determine that a T occurs at locus 520 when A occurs at locus 510. Such a composite genome could result from many different mixtures, and thus the exact genome of any one type of cell may not be known (depending on the complexity), but the composite genome can be determined via embodiments.

To address this challenge, techniques described can detect variants based on variable allele fraction values that represent the percentages of the population of alleles, at various genome loci, that are sequenced from the nucleic acid fragments included in a biological sample. For example, a hypothesis can specify that an particular allele is at a particular locus in 20% of the DNA material of the sample, and not present in the remaining 80% of the DNA material of the sample. Each allele in a hypothesis can have a corresponding allele fraction. Embodiments using a VAF (variable allele faction) model can assign scores that reflect this possibility of hypotheses with alleles having variable allele fraction values.

### IV. VAF Method

The variable allele fraction model can also use a Bayesian model to determine the likelihood of any given hypothesis. In one aspect, the Bayesian model now receives an allele fraction along with the alleles that make up the hypothesis. This hypothesis can viewed as the hypothesis for the composite genome for any cells being analyzed, and thus is not restricted to a hypothesis for only one cell. Specific related to embodiments using a Bayesian model are provided below, along with examples, and processes according to embodiments of the present invention.

A. Bayesian Model with Variable Fraction

In some embodiments, a hypothesis Hᵢ consists of the alleles S_{i,k}, and for each allele S_{i,k} there is a corresponding allele fraction f_{i,k}. The allele fraction represents the fraction of haplotypes in the DNA sample containing the allele. In various implementations, hypotheses can have any number of alleles, but may be restricted to 2 or 3 for computational efficiency, without much sacrifice in accuracy. In other implementations, the allele fractions can also have any value, or can be restricted to be above a certain threshold (as is discussed later). Under the assumption that each DNB (or more generally mate pair) is equally likely to originate from any of the haplotypes in the sample, P(DNB|Hᵢ) can be computed as follows:

$$P ( DNB \vert {H}_{i} ) = {\sum }_{k} {f}_{i , k} P ( DNB \vert {S}_{i , k} ) \qquad ( 2 )$$

Thus, embodiments can solve a general problem where there may be more than two alleles, and where the allele fraction for each allele is not constrained to be the same for each allele. This is particularly important for discovering somatic variants in cancer, as well as variants in non-diploid regions of a normal genome. For example, under the assumption that a cancer tissue is completely diploid, but the sample of that cancer is contaminated by normal tissue, there may still exist four distinct haplotypes with varying allele fraction. Additionally, the cancer tissue itself may be heterogeneous, composed of many different cells, each with its own heredity and somatic mutations. Note that a homozygous hypothesis can be represented with f_{i,k}=1, where other f_{i,*}=0. A standard heterozygous (i.e. equal heterozygous) hypothesis can be represented with two f_{i,k}=0.5 for allele k and f_{i,j}=0.5 for allele j.

B. Example Model of DNB Generation

In some embodiments, in equation (2) above, to evaluate a likelihood of a hypothesis, logic can estimate the probability for each DNB, P(DNB|S_{i,k}). A DNB may be generated at any position in the genome, with reads and gaps between the reads. The position where a DNB arises and the gaps between the reads are indicated in a mapping. Thus, the likelihood of generating any given DNB can be determined by summing the likelihood of generating the DNBs over all possible mappings M.

$$P ( DNB \vert {S}_{i , k} ) = {\sum }_{M} P ( DNB , M \vert {S}_{i , k} ) \\ P ( DNB \vert {S}_{i , k} ) = {\sum }_{M} P ( DNB \vert M , {S}_{i , k} ) P ( M \vert {S}_{i , k} ) \qquad ( 3 )$$

The sum of P(M|S_{i,k}) increases with the length of S_{i,k} giving rise to a so-called “insertion penalty”, which is modeled in the assembly pipeline. For example, it may be assumed that the likelihood of a DNB arising is the same at any position within the genome, and the change in DNB likelihood due to change in length of the genome for any two hypotheses is roughly equal. In that case, the likelihood ratio in equation (1) is unaffected by the likelihood of DNB arising at any given position, and the factor P(M|S_{i,k}) needs to simply account for the likelihood of the gaps. The gaps likelihoods can be determined empirically during the mapping stage of assembly. The gaps within each arm are modeled as dependent on sequence near the enzyme cut sites, and the small gaps of the left arm, mate gap, and small gaps of the right arm are modeled as independent of each other.

P(M|S_{i,k})=P(g_{L}g_{M}g_{R}|S_{i,k})

P(M|S_{i,k})=P(g_{L}|S_{i,k})P(g_{M}|S_{i,k})P(g_{R}|S_{i,k})

The remaining factor to resolve in equation (3) above is P(DNB|M,S_{i,k}). Assuming that each base call is independent, P(DNB|M,S_{i,k}) is simply the product of base call likelihoods b in DNB:

$$P ( DNB \vert M , {S}_{i , k} ) = {\prod }_{b in DNB} P ( b \vert M , {S}_{i , k} )$$

Where the base call matches the hypothesis allele for the mapping, P(b|M,S_{i,k}) is the likelihood the base call is correct. The likelihood that a base call is correct can be determined empirically during the mapping stage for correct base calls, dependent on the base call score, read cycle, and field within the flow device using during sequencing. If ε is defined to be the likelihood that the base call is incorrect, for bases that mismatch the hypothesis the assembly pipeline can assume the likelihood of any given base call is ε/3.

Sometimes the DNA sequence of a DNB may be modified during the library process. For example, a SNP or indel may be introduced into the DNB. In the case that a SNP is introduced, the above process of empirically estimating base call likelihood also accounts for SNPs within the DNA of the DNB, except where the SNP occurs at the same position as an overlapping base call (referred to as “negative wobble gap”). In that case, two correct base calls are likely to result, each discordant with the correct value of the hypothesis. If θ is denoted as the likelihood a SNP is introduced at any given position within the DNB, then the likelihood of two base calls that are concordant with each other but discordant with each other turns out to be roughly θ/3, under simple assumptions about the likelihood of any given transition or transversion. In one embodiment, an assembler models this possibility with θ=0.0015.

In one embodiment, an assembler also models the likelihood of an indel being introduced in the DNB, but this model refinement may only be employed during hypothesis rescoring, described herein, due to practical considerations.

The likelihood P(DNB,M|S_{i,k}) can be summed for all possible mappings. As there can be billions of such mappings for every DNB, in one implementation only the likelihoods for all “good” mappings (e.g., mappings with few discordant base calls with respect to the hypothesis) are summed, and a term, α, is added to the likelihood of generating each DNB, where α represents the likelihood of generating the DNB from a “bad” mapping. In some implementations, the α term is set at 10⁻⁹, but different values may be tried to see if assembly metrics can be improved by modifying this value. The ≢ term can serve as a catch-all to deaden the signal of “bad” DNBs—those which arise by means which are not well modeled by the Bayesian math. The α term can also act as a substantial coverage tax, deadening the signal from as much as 15% of good DNBs with low quality base calls. To address this coverage tax issue, one embodiment uses a different mechanism to limit the support of any given DNB to a hypothesis; this mechanism is described as hypothesis rescoring.

C. Score vs. AF for a Hypothesis

In some embodiments, a probability score of a hypothesis is defined to be the likelihood ratio in equation (1), such that Hⱼ is the reference hypothesis, expressed in decibels. Under the Bayesian probability model described above, logic can determine the score for a heterozygous hypothesis for any allele fraction, e.g., under the assumption that ε=1% for all base calls (which is slightly higher than the geometric mean of E for a typical sequencing run).

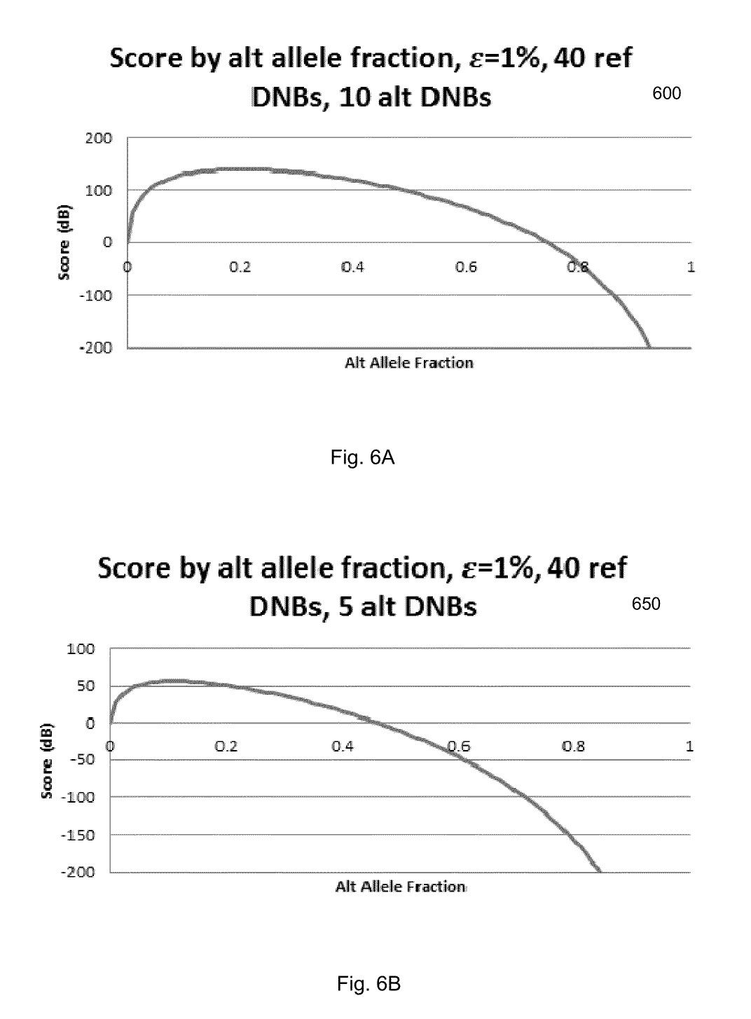

FIG. 6A shows a graph 6500 illustrating a scenario where there are 40 DNBs in favor of the reference and 10 DNBs in favor of an alternative SNP according to embodiments of the present invention. The vertical axis shows the probability score. The horizontal axis is allele fraction for the alternate allele from 0 to 1. Each value on the horizontal axis corresponds to a different hypothesis. As shown, a strong signal exists for the alternative allele, as the maximum probability score is ˜140 dB, more likely than homozygous reference allele (corresponding to value at 0). Since any allele fraction between 0.04 and 0.5 has a probability score within 40 dB of the most likely allele fraction (which can be determined to fall within a threshold), more than one allele fraction can be saved for an optimized list of hypotheses.

FIG. 6B shows a graph 650 illustrating a scenario where there are 40 DNBs in favor of the reference and 5 DNBs in favor of an alternative SNP according to embodiments of the present invention. Graph 650 demonstrates the power of using a model that allows for a non-diploid allele fraction. Under the diploid assumption, the homozygous hypothesis (0 allele fraction) is more likely than a heterozygous hypothesis with 0.5 allele fraction. However, graph 550 shows that the score at allele fraction ˜0.1 is substantially higher than the homozygous reference hypothesis.

In one embodiment, the maximum of the curve (i.e. the allele fraction with the maximum probability score) can be approximated as the ratio of the reads that are different than the reference. For triploid or higher hypotheses, the same percentage can be used for a surface plot, or higher dimensional plots for hypotheses greater than triploid. The probability may then be taken at these points. Refinement can be made by sampling points in the vicinity of the initial guess to determine the point with the highest probability. Such refinement may be needed when two hypotheses are of similar likelihood, which may occur in low complexity regions (e.g., homopolymer runs and other low-complexity sequences of recurrence period). The percentage of each of the alleles can be determined by counting the reads corresponding to each allele at a locus or via another mechanism.

The identification of a likely interval (e.g., in block 220 of method 200) can use the percentage or a probability at the percentage, or both. For example, if the percentage of any variant allele is greater than a threshold, then the region can be flagged as a variant region that likely has a variant. Or, if the probability score for any allele fraction is greater than a threshold (e.g., 10 or 20 dB) then the region can be flagged as a variant region that likely has a variant.

D. Method

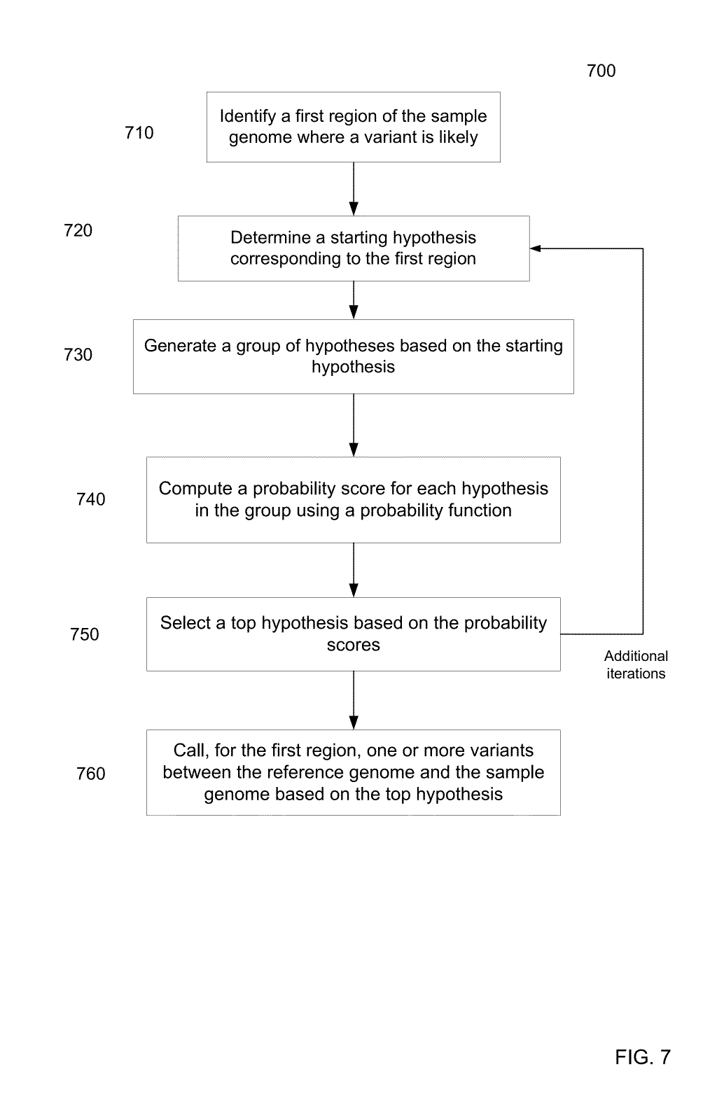

FIG. 7 is a flowchart of a method 700 using variable allele fraction to determine possible variants in a sample genome according to embodiments of the present invention. Method 700 can be performed using all or parts of system 100. Reads and mappings of the reads can be already obtained.

At block 710, a first region having a high likelihood of containing a variant is identified. For example, the region can include a locus having an alternative allele (different than the reference) that appears in mapped reads with a percentage above a threshold. As another example, the percentage of the alternative allele can be used as an input to a probability function (e.g., the Bayesian VAF model described herein) to determine if the probably score is above a threshold. Other allele fractions near the empirical value (i.e., determined from ratios of reads mapped to the locus) can be searched to find a higher probability score.

At block 720, a starting hypothesis of the sample genome in the first region is determined. The starting hypothesis can be seeded in a variety of ways, e.g., as described herein. Process 700 can repeat by using a top hypothesis for one iteration and using that as a starting hypothesis for other iterations. In one embodiment, the starting hypothesis specifies each allele in the first region and a corresponding allele fraction. In another embodiment, the starting hypothesis can simply be assumed to be homozygous. An input of an initial ploidy can be provided (e.g., diploid for autosomes, and monoploid for a Y chromosome if relevant).

At block 730, a group of hypotheses is generated based on the starting hypothesis. Each hypothesis is of the sample genome in the first region (e.g., the allele fractions of a composite genome). At least one of the group of hypotheses includes a plurality of alleles and a respective allele fraction corresponding to each of the plurality of alleles. Thus, at least some of the hypotheses use variable allele fraction, where an allele fraction is specific for each allele in the first region of the sample genome.

In one implementation, each hypothesis that is generated for the group has a different set of one or more alleles. For example, if the first region includes two hets (as in sample 503 in FIG. 5), one hypothesis might have three alleles (represented as TA, TG, and CG), another hypothesis might have only two alleles (TA and TG), and yet another hypothesis might also have three alleles (CA, TG, and CG). The allele fractions for each allele in a hypothesis can be optimally determined to provide the highest probability score (or nearly the highest) for that set of alleles. For instance, techniques described for FIGS. 6A and 6B can be used.

At block 740, a probability score is computed for each hypothesis in the group using a probability function. The probability function (e.g., the Bayesian model described herein) receives an input of each allele of the hypothesis and the respective allele fraction (e.g., as depicted in equation (2)). A first hypothesis in the group of hypotheses can includes a first allele with a respective allele fraction between a minimum threshold fraction (e.g., 0 or 0.2) and 0.5. The minimum threshold can be chosen based on an expected error rate, as is described in more detail below. For example, the first hypothesis could have an allele fraction of 0.01 (i.e., greater than 0) or 0.49 (i.e., less than 0.5) and these values are used to determine the probability score of the first hypothesis. Other hypotheses can have any allele fraction for the alleles specified in the hypothesis, and may also be between a minimum threshold fraction and 0.5, be 0.5, be between 0.5 and 1.0, or be 1.0.

At block 750, a top hypothesis is selected based on the probability scores of the current group of hypotheses. A probability score can be obtained for each hypothesis in the group and the hypothesis with the highest probability can be selected as the top hypothesis. In one embodiment, all of the probability scores can be stored and output if desired. In another embodiment, once a next hypothesis is found to have a probability score greater than the current highest score (and corresponding hypothesis) can be dropped from storage.

Optimization logic 134 in FIG. 1 is an example of logic that is configured to perform block 750. For example, if a particular hypothesis in the group has a better score than the starting hypothesis, then the computer logic selects this particular hypothesis as a new starting hypotheses; the computer logic can the uses the new starting hypothesis to repeat block 730 (e.g., by generating a new group of hypotheses for the region) and block 740 (e.g., by scoring each hypothesis in the new group of hypotheses). The computer logic may repeat this process one or more times until the current starting hypothesis has a better score that any hypothesis in the current group of hypotheses.

At block 760, one or more variants can be called between the reference genome and the sample genome in the first region based on the top hypothesis. This variant caller can be performed as described herein. In one embodiment, the variant caller can analyze a list of the highest scoring hypotheses (e.g., top 2, 3, or more) to determine whether a variant can be called. For example, a variant score can be determined (as described herein) and that variant score can be compared to a threshold, where variants below the threshold can be no-called. Any of the scores and corresponding hypotheses can be sent to later stages (e.g., as described in method 200) and be output.

After calling the variants for a given region, a computing device or computer logic thereof may repeat method 700 for any other region(s) that may have been identified as potentially including variants (e.g., such as small variants).

For most regions of the genome (the autosomes, and chrX for females), the logic generally performs the optimization procedure on hypotheses with two alleles. In some cases, such as regions in the chrY for males, the logic may perform the optimization procedure on hypothesis with one allele. When considering a heterozygous hypothesis, the optimization procedure can find the maximum likelihood allele fraction for each allele, such that the sum of allele fractions is 1.

In one embodiment, the group can be generated at block 730 by deviating from the starting hypothesis by a single-allele variation, as is described herein. In another embodiment, the group can be generated from a local de novo process, e.g., using de brujin graphs, e.g., as described herein and in U.S. patent application Ser. No. 12/770,089. In one implementation, a group of hypotheses are generated by a local de novo process and a top hypothesis selected based on probability scores determined in block 740. The top hypothesis can then be used in a new iteration that tries all possible one-base variations to generate a new group of hypotheses.

E. Triploid

In one embodiment, initial hypotheses can be constrained to be diploid. Upon completion of an optimization iteration to determine a list of top diploid hypotheses, logic can begin a new iteration and evaluate the triploid hypothesis considering the alleles of the top two diploid hypotheses. If the likelihood of a triploid hypothesis is at least a minimum amount (e.g., 20 dB) greater than the likelihood of the most likely diploid hypothesis, the triploid hypothesis can considered to be the top hypothesis for the current iteration. Otherwise, the most likely diploid hypothesis is considered to be the top hypothesis. Note that when the optimization procedure works on a small region (up to 200 reference bases), it is unlikely there will be more than three distinct haplotypes in such a region. But, if needed, a triploid hypothesis is the top hypothesis, it can be used to generate hypotheses with four distinct haplotypes (alleles). In another embodiment, triploid hypotheses can be tested during a same iteration as diploid hypotheses are tested.

As mentioned above, a hypothesis is not restricted to a diploid hypothesis in a VAF method. Triploid hypotheses may be able to better resolve somatic variations that are adjacent to germline variations. These modifications result in higher sensitivity to small variants (SNPs and indels). Simultaneously, deeper sequencing increases the probability of detecting variants at low allele fraction. In combination, embodiments and higher coverage can result in improvements for SNP detection in diploid regions and for chromosomal regions exhibiting allelic imbalance.

F. Minimum Threshold Fraction

One challenge of using variable allele fraction values in variant detection is that in the limit, as allele fraction goes down to 0, a truly heterozygous locus would look a lot more like a homozygous locus because there is not a lot of the differing alleles present in the reads obtained for that locus from the biological sample. For example, the reads for a particular locus obtained from a biological sample may include only 5% of allele A and may include 95% of allele B for this same locus. This case can be very difficult to distinguish from the homozygous case (in which the reads obtained from the sample include 100% of allele B) because a small number of reads may contain sequencing errors. The same difficulty is reflected in the scoring of variants, e.g., if the likelihood that the biological sample indicates 1% allele A and 99% allele B, then the likelihood of this being in fact true (according to the likelihood model) will be almost exactly the same as the homozygous likelihood of having 100% of allele B.

In one embodiment, as long as a single read in support of a non-reference hypothesis exists, the maximum likelihood heterozygous hypothesis will always be more likely than the homozygous reference hypothesis because this model is not constrained by hypothesis priors. For example, under the assumption that all base calls are equally good, if there are 99 reads in support of the reference and one read in support of a SNP, the hypothesis where f_{ref}=0.99 and f_{SNP}=0.01 (allele fractions for the two alleles) is more likely than the homozygous reference hypothesis, by a minute amount.

However, in one implementation, the optimization uses a maximum likelihood allele fraction as the variable allele fraction only if the allele fraction is at least 0.2 (or some other threshold) for each allele. The threshold can be chosen based on the error rate. If the error rate is lower, than the threshold can be lower. For example, if error rate for base calls is 1%, then an embodiment can have a threshold around 1%. A further constraint can be to accept a hypothesis only if the maximum likelihood is at least 20 dB more likely than the hypothesis where one of the two alleles has allele fraction 0 (i.e., homozygous). If these criteria are not met, the heterozygous hypothesis can be constrained so that the allele fraction is equal for all alleles so that an equal allele fraction (EAF) model is used.

Thus, a hybrid maximum likelihood allele fraction model can be provided. In this way, the assembler is able to detect alleles present at low allele frequency, as long as there is strong support for them; the assembler is able to make homozygous calls where there is strong support that a homozygous hypothesis is more likely than a diploid heterozygous variant; and the assembler is able to no-call where there is little support or substantial conflicting support.

G. Hybrid

Embodiments using a hybrid maximum likelihood allele fraction model can calculate probability scores based on two likelihood models, variable allele fraction (VAF) and equal allele fraction (EAF). In one embodiment, only one of the models is used for a particular hypothesis. In another embodiment, both models can be used to give the score for the maximum likelihood allele fraction as varScoreVAF and the score for the equal allele fraction as varScoreEAF.

In one embodiment, an evaluation is performed to determine whether to use VAF or EAF. This evaluation can include determining whether one or more conditions are satisfied for a given hypothesis. For example, a condition may be that an allele fraction is above a threshold value. If a hypothesis has allele fractions above the threshold, then VAF may be used, and EAF used if the condition is not satisfied. In another example, a condition may be a threshold value for the difference of the probability score of the hypothesis from the probability score of a homozygous hypothesis for a variant region. Multiple conditions may be used.

In this manner, by evaluating various condition(s) and determining whether to use variable or equal allele fraction values for the alleles of a given hypothesis, the techniques described herein can address a difficulty in calling the variants (including small variants) in a given genome region when the reads obtained from a biological sample for that region indicate low-frequency alleles. For example, a variant caller can detect alleles present at low allele frequency as long as there is strong support for these alleles in the underlying reads. Further, the variant caller is able to make homozygous calls where there is strong support that a homozygous hypothesis is more likely than a diploid heterozygous variant, and to make no-calls where there is little support or substantial conflicting support for the hypothesis in the underlying reads.

Using the two scoring methods can maximize sensitivity and specificity in either diploid or non-diploid regions of genome. In one embodiment the varScoreVAF and varScoreEAF, which are computed based on the Hybrid Maximum Likelihood Allele Fraction Model, are used as indicators of variant quality. The varScoreEAF yields a better ROC for variants at equal (e.g., 50%) allele fraction, and the varScoreVAF yields a better ROC for variants at variable (for example, 20%) allele fraction. In one implementation, variants are called based on varScoreVAF, but both scores are provided.

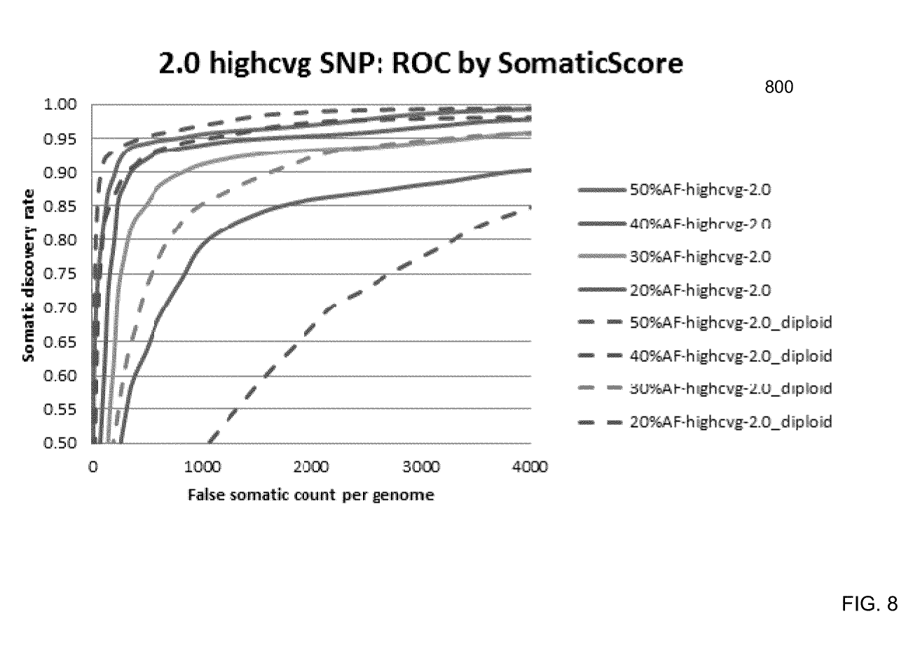

FIG. 8 is a graph 800 illustrating an example of the ROC for somatic events determined based on the techniques described herein. For variants that are diploid, the varScoreEAF is used, and the somatic scoring assumes all variants are diploid. For variants not marked as diploid, the varScoreVAF is used, and the somatic scoring does not assume all variants are diploid.

As illustrated in graph 800, the variant cases using the diploid assumption and varScoreEAF have a slight edge at high allele fraction. Further, the sensitivity gain for variants present at low allele fraction (like 20% AF) is clearly discernible in graph 800. In one implementation, use of varScoreVAF is recommended unless there is substantial prior knowledge that the variant of interest is present with at least 50% allele frequency. A more precise treatment of call quality may factor in all of the following: variant type (SNP, insertion, deletion, or substitution), score (varScoreVAF, varScoreEAF, or reference score), local coverage and call type (e.g., whether this call is heterozygous or homozygous, reference or variant).

### V. Hypothesis Rescoring

During a sequencing process, an base can be called in error, or potentially an errant molecule may be formed in the biochemistry involved in the sequencing procedure (thus the base may exist, but the molecule itself is in error). Some embodiments use a term that puts a limit on the support a given mate pair can contribute to hypothesis scoring. In these embodiments, such a term is used to model the possibility that some nucleic acid construct (from which a mate pair is sequenced) was generated outside the expected model, e.g., by arising through an unknown biochemical process. In these embodiments, such term can be used to obtain more accurate results.

For example, even the most tightly controlled library preparation process can generate unexpected or unusual nucleic acid concatemers (from which mate pairs are sequenced) because of the nature of the biochemical reactions that take place during such a process. Thus, if the hypothesis generation process modifies a hypothesis such that a mate pair sequenced from a chimera concatemer appears to map well to the genome, that single mate pair can provide an overwhelming (but wrong) support that a particular mutation exists. To avoid this unwanted effect, some embodiments use a term (also called an α-term) that represents a likelihood that any given concatemer can get generated no matter what (even without good mappings). However, a problem with using such α-term is that this term may be bigger than the likelihoods that the mappings of some mate pairs are correct. In effect, the α-term ends up being a coverage tax that would exclude from hypothesis scoring any actually correct mappings that have a likelihood of being correct that is smaller than the α-term.

To address this problem, the techniques described herein provide a hypothesis re-scoring mechanism that is able to achieve the same functionality but without having the coverage tax problems of the α-term. For example, in addition to using an α-term, some embodiments employ hypothesis re-scoring that is based on parameter(s) indicating the likelihood(s) that any given variant in a particular genome region is not present in a fragment but was generated by a library preparation process prior to sequencing. In these embodiments, alternative and/or additional scores may be computed for the hypotheses for a variant region (as well as for other hypotheses). The alternative and/or additional scores may be computed based on the values of a parameter, where one parameter value is used when two alleles in a particular hypothesis differ by a one-base indel, and a different parameter value is used when the difference between the two alleles is longer and/or different than a one-base indel.

In some embodiments, given the limited number of hypotheses that need to be scored at this stage, it becomes computationally feasible to correct for some model limitations such as, for example, the limitation that individual DNBs can provide overwhelming support for a hypothesis. For example, in the optimization stage, a DNB may map to the top hypothesis with no discordances, but have no mappings to the reference hypothesis. In this case, based on the Bayesian Modeling, the likelihood of the DNB given the reference hypothesis is α, which in some implementations may be set to 10⁻⁹. However, the likelihood of the DNB given the top hypothesis where there is a good mapping may be higher than 10⁻³. Thus, this DNB may support the top hypothesis by over 60 dB. This overwhelming support for the top hypothesis may become a problem when such DNBs arise from unmodeled errors in the library preparation process that generates the underlying nucleic acid fragments from the sample (e.g., such polymerase stutter in PCR amplification or formation of DNB chimerism). Thus, a goal of this rescoring stage is to limit the influence of even the best single DNB in accordance with a model that assumes that even the best DNBs could arise due to artifacts in the process of DNB construction.

Suppose that in the above example where the DNB maps with no discordances to the top hypothesis but has no mappings to the reference hypothesis, the DNB supports a het insertion. It is possible this DNB actually originated from a DNA fragment that corresponds to a reference sequence, but the base was inserted during PCR or some other process before sequencing. To model this behavior, an ideal solution is to map DNBs to the hypotheses with indels, and extract a penalty for an indel in a mapping, in accordance with what the likelihood is that any given indel occurs during the process of DNB generation. But mapping with indels can be a very expensive and complex proposition in terms of computing resource usage.

One embodiment assumes the likelihood of any given variant arising within a DNB during the DNB construction process is β, where P(DNB|reference)≧βP(DNB|variant). Thus, the logic at hypothesis rescoring stage uses this fact to ensure that no DNB provides overwhelming support for a hypothesis. It increases P(DNB|S) for every allele S to ensure that, for each pair of alleles Sᵢ and Sⱼ within this universe, P(DNB|Sᵢ)≧βP(DNB|Sⱼ). When Sᵢ and Sⱼ differ by only a one-base indel, the β parameter is set to 0.001, β=0.001. Otherwise, the β parameter is set to 0.0001, β=0.0001. β may be changed to more accurately correspond to the likelihood of the particular difference between Sᵢ and Sⱼ arising during DNB construction.

It is noted that the use of α and the mechanism employed by hypothesis rescoring are two ways to achieve, among other things, a limit to the support of any given DNB to a hypothesis. One main difference between the two is that as α is raised, a coverage tax is introduced. The likelihood of some DNBs is never as high as α, even for the correct hypothesis, and even if there is high certainty that no other placement of the DNB within the genome is correct. Hypothesis rescoring based on the β parameter, however, implies no such coverage tax. It merely deadens the signal of the best DNBs, in accordance with the model that even the best DNBs could arise due to artifacts in the process of DNB construction.

Accordingly, hypothesis rescoring logic 136 can rescore varScoreVAF and varScoreEAF (e.g., probability scores determined under the VAF and EAF models, respectively), given the top hypothesis and the next-best hypotheses identified at the variant calling stage. Additionally, hypothesis rescoring can also achieve a reduction in the false positive rate by ensuring that individual DNBs cannot provide overwhelming support for a hypothesis. As the result of this stage, the computer logic can store and/or output in one or more suitable data structures on persistent and/or temporary storage the following data: a set of variants, along with rescored varScoreVAF and varScoreEAF that are further considered in a later stage (e.g., the correlation filtering stage).

### VI. Replicate Calibration

The probability scores provide a likelihood of a hypothesis (and thus a variant) based on the underlying reads. However, the underlying sequencing data could have errors, and the model could have inaccuracies. Thus, the accuracy of a variant call may not be exactly known. Some embodiments can determine an expected accuracy (e.g., a false positive rate and false negative rate for calling variant) using a calibration sample. This expected accuracy can be determined for various combinations of variant scores, along with other parameters. Such a table can be determined once, and then used for subsequent samples. Thus, the expected accuracy from the table can be used in analyzing samples from a patient based on variant scores (and potentially other parameters).

In some embodiments, replicate calibration techniques are based on information from a process in which DNA from the same biological sample is sequenced and assembled into two or more genomes in two or more separate sequencing operations. In one example, DNA from the same sample is separated in two portions, the two portions are prepared into two separate libraries, and the two libraries are sequenced separately in separate sequencing runs. Two genomes (respectively corresponding to the two libraries, e.g., genome A and genome B) are then assembled, and the variants in each of the two genomes are called. Due to the nature of the library preparation process and of the sequencing operations, there may be some discordances between the variants called in the two genomes at some (albeit few) loci. For the purposes of replicate calibration, it is assumed that all these discordances are in error—for example, either a variant in genome A at a given locus is called in error (false positive) or the reference call at the same locus in genome B (false negative) is made in error. Thus, there is an uncertainty about which one of these two situations has actually occurred—whether the variant call in genome A was actually incorrect or whether the reference call in genome B was actually incorrect. A likelihood that a variant is a false positive or a likelihood that a non-variant call is a false negative can be determined for a calibration sample.

For example, in one embodiment a replicate calibration logic (e.g., as embodied in computer system 130) takes as input coverage information (e.g., counts of reads and mappings for each different type of variants) and initial estimates of the scores for the discordant loci, determines the respective likelihood that each discordant loci is false positive or false negative based on the initially estimated scores, empirically constructs improved estimated scores, and iteratively performs the same steps with the new estimates until the calibrated scores converge. The replicate calibration logic can make certain assumptions about what the true score is at the beginning, and then iteratively tests whether a replicate discordance is a false negative or a false positive until the score converges to a value referred to as the “calibrated score”. These calibrated scores can be stored in a table, with a different score corresponding to a different range of input information.

When a new sample is tested and variants called, with corresponding variants scores, a likelihood of the variant being a false positive can be determined from the calibrated scores from the table that was computed using a calibration sample. Additionally, certain loci may be known to check for false negative as they may be likely areas of a variant from previous measurements of other samples. These likelihoods (calibrated scores) may be output in one or more files and may be used by other processes (e.g., to compute a new type of somatic scores, as described below).

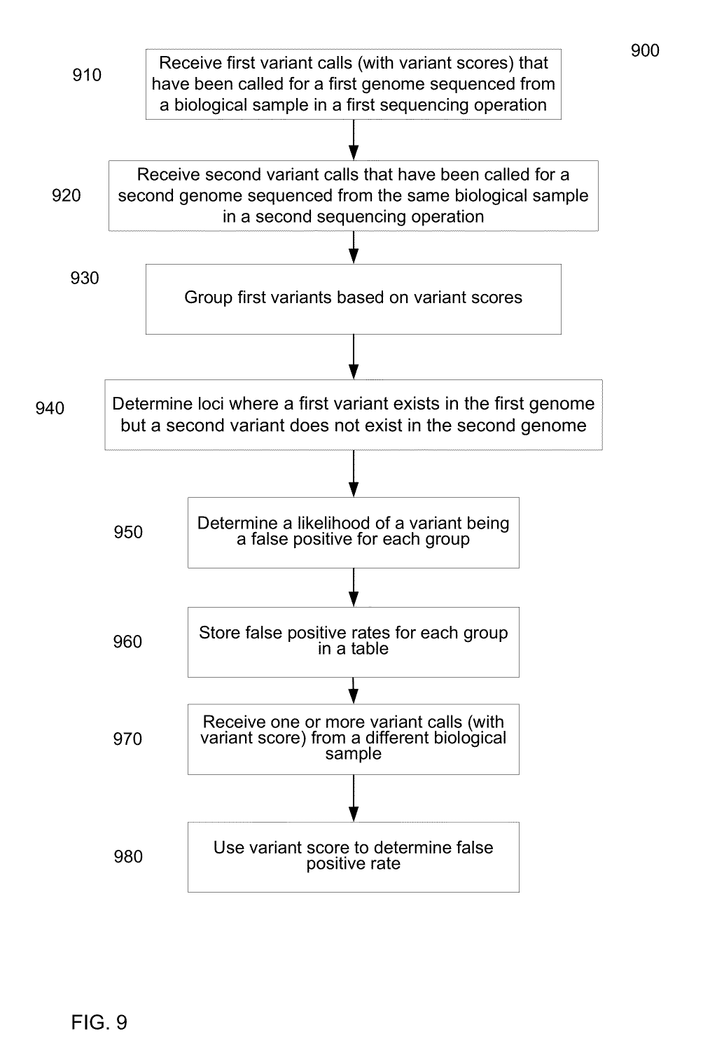

FIG. 9 is a flowchart of a method 900 for determining an error rate for a variant call in a genome of a sample according to embodiments of the present invention. As with other methods, method 900 can be performed by a computer system, including logic, as described herein. A variant call is a different from a reference, and can be determined as described herein.

At block 910, a computer system can receive first variant calls that have been called for a first genome sequenced from a biological sample (calibration sample) in a first sequencing operation. For each variant call, a variant score can be received, e.g., variants scores as computed using embodiments herein. Additionally, related metrics (e.g. such as coverage information) about the variant call and the first sequencing operation can be received. For instance, the type of variant (e.g., SNP, insertion, deletion, or substitution) can be provided and the number of reads mapping to a locus.

At block 920, the computer system can receive second variant calls that have been called for a second genome that has been sequenced from the same DNA sample in a second sequencing operation. The corresponding variant scores may be received. For example, a sample can be split into two parts and each separately sequenced to independently determine a genome. One would expect the variant calls to be the same, since they are from a same sample. However, they may not be the same due to errors. Related metrics can also be received for the second variants and the second sequencing operation, which may use the same technique as the first sequencing operation, but simply performed on different nucleic acids from the same sample. In one embodiment, reference scores from the second genome are received.

At block 930, the first variants are grouped into a first set of buckets (groups) according to variant score. For example, all of the variants having a variant score between 0 dB and 10 dB (including 10 dB) can be placed into one group and all of the variants having a variant score between 10 dB and 20 B (including 20 dB) are placed into another group. Other groups can be formed, and the ranges of variant scores for a group can vary and be any suitable range. The discordant variants can also be grouped by other parameters, such as variant type. Thus, a bucket can be the variants with a variant score with a specified range, specific variant type, and range of reads mapping to a locus.

A purpose of the grouping is to assign a likelihood that a discordance is a false positive vs. a false negative for each group. These likelihoods can then be used to predict the likelihoods for other samples for which just one sequencing operation is run. For example, a variant score in the range of 10-20 dB can be assumed to have a same likelihood of being a false positive as determined using a calibration sample. As another example, a reference score in the range of 0-10 dB can be assumed to have a same likelihood of being a false negative as determined using a calibration sample.

At block 940, discordant loci where a first variant exists in the first genome but a second variant does not exist in the second genome are determined. This inconsistency is called a discordance. A discordance occurs when a variant is called at a locus in the first genome, but not in the other. A discordance can occur by a variant being falsely called (false positive) or a true variant not being called (false negative). The number of discordant and concordant variants can be tracked for each group.

At block 950, a likelihood of a variant being a false positive is determined for each group. For example, the number of discordant variants in a group can be used to determine the likelihood of a variant being a false positive. Even if it is assumed that there is an equal chance a discordant variant is a false positive in the first genome or a false negative in the second genome, the number of discordant variants for a group can be used. For example, if a first group has 10% discordant loci, then a false positive rate of 5% can be assumed.

In other embodiments, the exact variant score in the first genome and the reference score at a discordant loci can be used to determine the false positive rate. If the variant score is greater than the reference score, then the likelihood of a variant is more likely than not. Thus, a higher likelihood of a false negative than a false positive can be used, with the sum being equal to one. Thus, if each of the 10% discordant loci have 70% chance of being a false negative and a 30% false positive, then the false positive error rate for the first group can be 3% (e.g., as 10% of 30%). Each discordant loci could have different percentages for false positive and false negatives, but a sum of the false positive rates for each discordant loci can be computed and then normalized by the number of loci in the group. For example, 0.3+0.5+0.2 gives 1.0, which is divided by 30 (e.g., if 10% are discordant) to give 3.33% as the false positive rate.

In one embodiment, a likelihood of a variant being a false negative can also be determined for groups of reference scores obtained from the second genome. The reference scores used to call the reference can be grouped in a similar manner as the variant scores for the first genome. The discordant loci in each group can be used to determine a false negative for each group.

At block 960, the false positive rates for each group are stored in a table. The table can be any data structure that allows the groups to be access to obtain the false positive rate for a particular group. In one embodiment, the table can have multiple dimensions besides grouped by variant score (e.g., coverage or other metrics). Each metric would correspond to a different dimension of the table. Another metric could be allele fraction. These false positive rates can be used for a variety of purposes, e.g., just to filter out variants with high false positive rates. The table can be used to determine this for new variant calls of new samples, as follows.

At block 970, one or more variant calls (with variant score) from a different biological sample are received. The variant calls and scores may be computed as described herein. Besides the variant score, other metrics described herein can also be computed.

At block 980, the variant score is used to access the table to obtain a false positive rate for the variant score. This false positive rate can be used to determine an accuracy for whether the variant is correct. Such a determination of accuracy can be used for a variety of purposes, such as somatic score.

A. Calibration Score

As described above, the replicate calibration techniques described herein can provide a likelihood of an error of a variant call. In one embodiment, the likelihood can be measured as a calibration score. In one embodiment, a calibrated score is defined as follows:

$$- 10 {log}_{10} \frac{P ( False call )}{P ( True call )}$$

Thus, given a calibrated score, the likelihood that the call is correct can be determined. The tables mentioned in block 960 can store these calibrated values.

In one embodiment, the result of replicate calibration is a set of calibration files (which can be stored as multiple tables that effectively form a single table). Each file provides the calibrated score given the uncalibrated score (e.g., either varScoreVAF, varScoreEAF, or reference score) and the coverage (for reference scores, the coverage reflects the counts of unique sequences, and for varScoreVAF or varScoreEAF the coverage reflects the total read counts determined for a genome). In some implementations, a calibration file may be chosen based on additional criteria, such as: the pipeline software version used to assemble the genome, the type of variant, the likelihood model (variable allele fraction, VAF, or equal allele fraction, EAF), the error mode (e.g., fp, fn, uc, or oc, as described below), and the allele frequency assumption (for most files, assumption is diploid 50% allele fraction, but some files indicate they are “af20” for the assumption of 20% allele fraction). These criteria (metrics) can be used as other dimensions in a table.

In an example embodiment, a calibration file comprises a set of data stored in rows and columns. Within each calibration data file, each column represents a coverage bin, and each row gives the calibration for a different score (e.g., a range). Each column header lists the minimum coverage value for the coverage bin. So, for example, if the columns of the file are score, cvg0, cvg20 and cvg30, then the cvg0 column refers to data where the coverage level is between 0 and 19, the cvg20 column refers to data where the coverage level is between 20 and 29, and the cvg30 column refers to data where the coverage level is 30 or higher.

Other dimensions of a higher dimensional table can use any of the criteria (metrics) mentioned herein. As examples, the failure mode can be one: of fp (false positive), fn (false negative), uc (undercall, or calling a heterozygote where the locus is truly homozygous alt), or oc (overcall, or calling a homozygote where the locus is truly ref-het).

B. Iterative Refinement of Calibration Score

Embodiments can include machinery to test the likelihood that a replicate discordance is a false positive or false negative (for undercall-overcall failure mode calibration, the tested likelihood is that of a replicate discordance being undercall or overcall), given calibrated scores for the calls in both replicate genomes. Concordant loci may be assumed true. To compute the calibration score, an iterative analysis via a feedback loop where the replicate calibration logic starts with initial estimates for calibrated scores, determines the likelihood each discordant site is false positive or false negative (or undercall or overcall) based on those calibration estimates, then empirically constructs improved estimates of the score calibration given the set of true and false calls. In an example implementation, the replicate calibration logic executes three iterations of this loop, and then outputs the result.

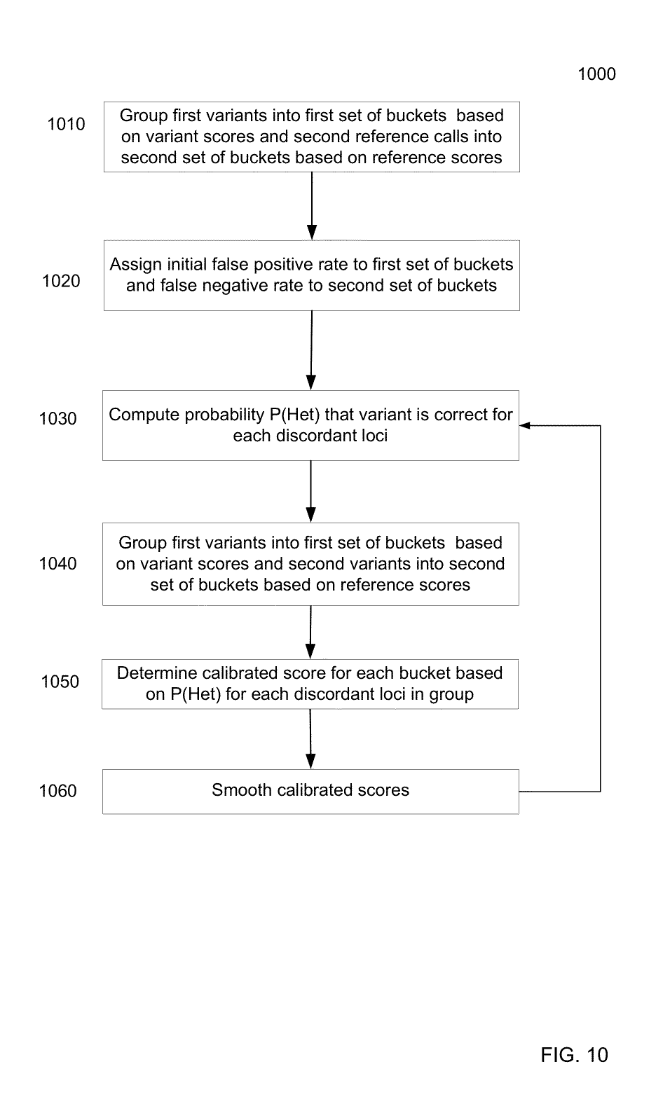

FIG. 10 is a flowchart illustrating a method 1000 for determining a calibration score according to embodiments of the present invention. Method 1000 may be used to implement block 950 of method 900. Thus, steps of receiving variants for a first and second genome from a same sample can precede method 1000, as well as determining discordant loci.

At block 1010, the first variants of the first genome are grouped into a first set of buckets according to variant score. Additionally, reference calls (i.e. where second genome equals the reference, and thus no variant) of the second genome can be grouped into a second set of buckets according to reference score. The second set of buckets can be used to determine a false negative rate.

At block 1020, an initial false positive rate is assigned to each of the first set of buckets (initial value can be same or vary), and similarly for false negative rates for second set of buckets. In some embodiments, the initial rates are between 0 and 1. In one embodiment, the initial values are 0.5 for both.

At block 1030, a probability P(Het) that a variant is correct is determined for each discordant loci. Note that each discordant loci has a variant score from the first genome and a reference score from the second genome. The probability can be computed as described below. Generally, P(Het) is computed from the variant calibrated score (false positive rate) for the group of the first set that the corresponding variant call belongs and the reference calibrated score of the group of the second set that the corresponding reference call belongs. The two calibrated scores depend on the respective variants within each group associated with the discordant loci, and thus the calibrated scores can be different for each group. This difference in calibrated scores can provide a difference in the false positive rate and the false negative rate for a discordant locus.

In one aspect, the probability P(Het) is generally larger if the false positive rate is less than the false negative rate. In one embodiment, P(Het) is between 0 and 1. It is noted that if P_{FP} denotes the probability of a false positive call, and P_{FN} denotes the probability of a false negative call, then P_{FN}=1−P_{FP}. P(Het) is equivalent to P_{FN}.

At block 1040, the first variants of the first genome are grouped into a new first set of buckets according to variant score. Additionally, reference calls (i.e. where second genome equals the reference, and thus no variant) of the second genome can be grouped into a new second set of buckets according to reference score. In one aspect, this re-grouping may be performed to ensure sufficient statistical accuracy across buckets. In other embodiments, the groups can stay the same across iterations.

At block 1050, a variant calibrated score is determined for each based on P(Het) for each discordant loci in a bucket of the first new set. For example, the P(Het) values for each discordant loci can be summed. Note the false positive rate can be computed as 1−P(Het). If the false positive rate is low and there are few discordant loci relative to concordant loci (i.e. where variants appear in both genomes), the variant calibrated score is higher (note that higher here is used in a relative sense, as any score can be inverted. A reference calibrated score can be determined similarly.

Referring back to the formula for the calibrated score, P(false call)+P(true call)=1, and P(false call)/P(true call)=sum of (1−P(Het))/(# of concordant loci+sum of P(Het)). Using these formulae and P(Het) for each discordant locus, the logic can then compute P(false call) and P(true call). P(True call) would change only if the buckets are changed, but P(false call) changes as P(Het) changes.

At block 1060, the variant calibration scores are smoothed. For example, the variant calibration scores generally increase with increase variant score, and the same for the calibrated reference scores. However, line connecting the data points may not be smooth. In one embodiment, a loess algorithm is used to smooth the calibration. The reference calibration scores can also be smoothed.

The replicate calibration logic may perform several iterations of this process until the improved estimated values converge to values that are within a desired confidence threshold or until a certain number of iterations have been performed. The improved estimated calibrated scores from block 1050 of the last iteration are assigned as used as the calibrated scores to determine P(H) for the next iteration. As the calibrated scores change, the value of P(H) changes, which in turn causes the calibrated scores to change, until convergence is achieved. Other runs can be performed to obtain data for other bins, where the number can be averaged.

As an example for computing a variant calibration score for two discordant loci in a group of the first set, assume that a first SNP call has a high variant call from the first genome and a low reference call from the second genome. But, a second SNP has a high variant call and a high reference call. Then, the reference calls of the two SNPS would be in different buckets of the second set. This different will affect P(Het) for the two discordant loci, as the first SNP will likely have a lower false positive value than the second SNP, since the reference calibration score for the second SNP should be lower. For instance, if P(Het) is computed as or proportional to a ratio of the variant calibrated score divided by the reference calibrated score, the first SNP would have a greater likelihood of being correct, since the denominator for the first SNP will be lower by virtue of the reference score being in a bucket of lower scores.

Once the calibrated scores are obtained, further operations may be performed. For example, the computing device or the replicate calibration logic may invoke another logic that uses the set of calibrated scores to compute other variant call metrics for the set of variant calls at the discordant loci (e.g., such as computing a new type of somatic score, as described below). These further operations can involve steps like 980 of method 900, by using the stored calibration scores to estimate the calibration score of a variant score from a different sample. In this manner, one genome needs to be determined for a new sample, as the likelihood of the variant call being correct can be assumed to be the same as the corresponding bucket in the table. This use of the calibration scores can similarly be used with the reference calibrations scores to determine a likelihood of a reference call of a new sample being correct based on the reference score.

In this manner, the replicate calibration techniques described herein allow for qualification of the raw scores that are assigned to variant calls by providing additional quantifying information. For example, if a given variant call is assigned a score of 50, replicate calibration can return information indicating what percentage of all variant calls with a score of 50 are in error (e.g., whether 0.1%, 1%, or 10% of these calls are in error). As described herein, replicate calibration is based on the empirical observation of where false calls and true calls are found and returns information indicating the expectation (e.g., likelihood) of whether a variant call is true or is in error given the call's raw score, the coverage, and the other metrics as described herein.

In one embodiment, the replicate calibration logic executes the score calibration separately for each type of variant varType (snp, ins, del, or sub), and separately for each likelihood model (variable allele fraction, VAF, or equal allele fraction, EAF). Additionally, the replicate calibration logic can execute method 1000 once to calibrate the false positive rate (FP) given a varScore (varScoreVAF or varScoreEAF) and false negative rate (FN) given a reference score, and once again to calibrate the undercall rate (UC) given the varScore of the reference call in a ref-het locus and the overcall rate (OC) given the minimum varScore of a homozygous alt locus. These are also referred to herein as the FP-FN calibration and the UC-OC calibration.

To calibrate the scores for a particular varType or score type, the replicate calibration logic can first categorize the loci in a replicate comparison as “homozygous concordant”, “heterozygous concordant”, or “discordant”. When performing the FP-FN calibration, the homozygous concordant sites are shared reference calls in the replicates; the heterozygous concordant sites are shared ref-het calls; the discordant sites are the sites where one genome has a ref-het call but the other genome has a homozygous ref call; and all other loci are discarded. When performing the UC-OC calibration, the homozygous concordant sites are shared homozygous alt calls in the replicates; the heterozygous concordant sites are shared ref-het calls; the discordant sites are the sites where one genome has a ref-het call but the other genome has a homozygous alt call and where the alt call is shared; and all other loci are discarded.

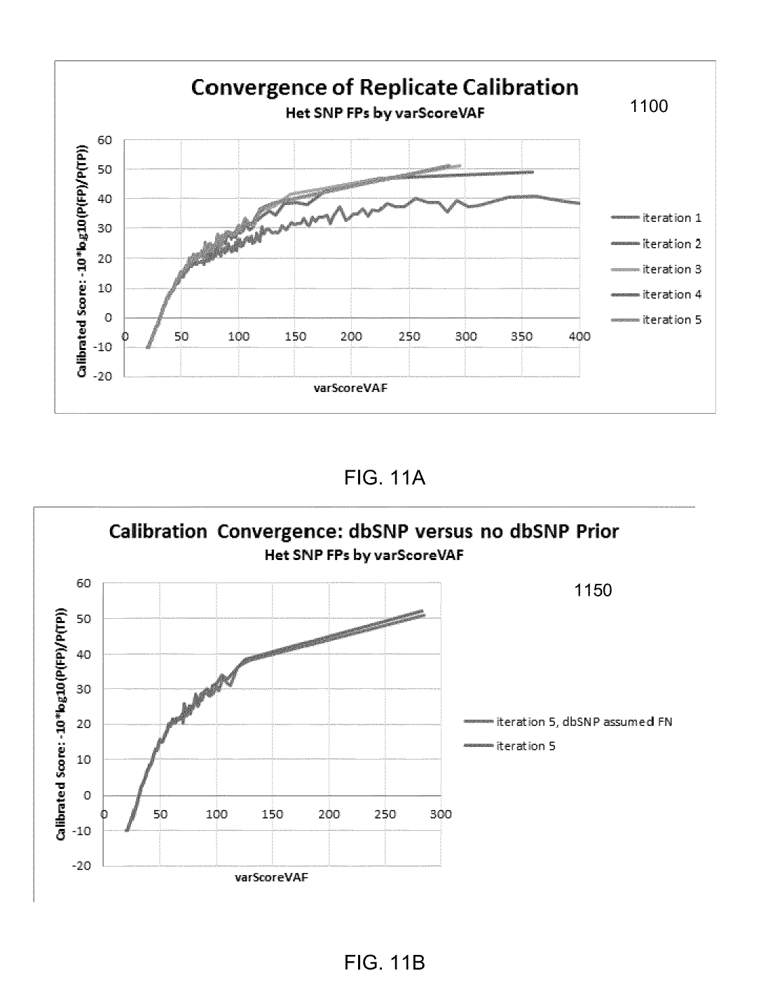

FIG. 11A is a graph 1100 showing pre-smoothed convergence for the case of a single coverage bin. As one can see, method 1000 rapidly converges to a solution. Graph 1100 illustrates that for the worst varScores, the replicate calibration indicates the calibrated score is −10, which indicates that false calls are 10× (i.e., 10 times) as likely as true calls. This is not entirely unexpected for varScore of 20, since het SNPs happen every 1000 bases or so, and this is not accounted for in the assembler's scoring logic. The best varScores achieve a calibrated score over 50, indicating there is one error every 100,000 true SNPs at this score, or one error every 100 million base positions or so (assuming a true SNP with such a good score every 1 kb). Also, gGraph 1100 illustrates that the calibration curve has a curvature that bends downward. If the model of DNB generation exactly matched reality and the assembler logic exactly predicted the likelihood any event is true, the curve would be completely linear. The curvature of the calibrated score line indicates that there are some events (DNBs) that occur outside the model of DNB generation and can be considered systematic artifacts.

FIG. 11B is a graph 1150 showing the accuracy of method 1000. If in the method 1000, block 1030 that determines P(Het) for the FP-FN calibration is modified so that all replicate discordances of dbSNP-known variants are assumed to be false negative, method 10000 converges on roughly the same false positive calibration, as for performing the iterative method.

C. Mathematical Model

A mathematical model underpinning the iterative refinement of score calibration according to one embodiment is as follows. Consider a locus within the replicate analysis of two genomes, genome A and genome B. hetScoreA is defined to be the condition that the locus is called heterozygous with a given score in genome A and homScoreB is defined to be the condition that the locus is called homozygous with a given score in genome B. Also, d is defined to be the condition that the locus is a replicate discordant locus, cᵣ is defined to be the condition that the locus is called homozygous in both genomes, and cₕ is defined to be the condition that the locus is called heterozygous in both genomes. n_{TP} is defined to be the number of true het loci in the genome, n_{FP} is defined to be the number of false called het loci, n_{TN} is defined to be the number of true homozygous loci, and n_{FN} is defined to be the number of false called homozygous loci.

Further, HetA is defined to be the condition that genome A is truly heterozygous at the given locus (and similar definitions for genome B and HomA). Het is defined to be the condition that both genomes are heterozygous at this locus and Horn is defined to be the condition that both genomes are homozygous at this locus. It is noted that under the assumption that the two genomes are replicates (i.e. the same genome), P(not HetA)=P(HomA)=P(HomB)=P(not Het)=P(Hom).

The analysis needs to determine the likelihood ratio

$$\frac{P ( Het \vert hetScoreA , homScoreB , d )}{P ( Hom \vert hetScoreA , homScoreB , d )} ,$$

or equivalently

$$\frac{P ( HetA \vert hetScoreA , homScoreB , d )}{P ( HomB \vert hetScoreA , homScoreB , d )}$$

given the calibration of hetScoreA

$$( i . e . {L}_{A} = \frac{P ( HomA \vert hetScoreA , {c}_{h} )}{P ( HetA \vert hetScoreA , {c}_{h} )} )$$

and homScoreB

$$( i . e . {L}_{B} = \frac{P ( HetB \vert homScoreB , {c}_{r} )}{P ( HomB \vert homScoreB , {c}_{r} )} ) .$$

First, Bayes' theorem is applied as follows:

$$\frac{P ( HetA \vert hetScoreA , homScoreB , d )}{P ( HomB \vert hetScoreA , homScoreB , d )} = \frac{P ( hetScoreA , homScoreB \vert HetA , d ) P ( HetA \vert d )}{P ( hetScoreA , homScoreB \vert HomB , d ) P ( HomB \vert d )}$$

Under independence assumption, the last quantity is equal to:

$$( 4 ) \\ = \frac{P ( hetScoreA \vert HetA , d ) P ( homScoreB \vert HetA , d ) P ( HetA , d )}{P ( hetScoreA \vert HomB , d ) P ( homScoreB \vert HomB , d ) P ( HomB , d )} \\ = \frac{P ( hetScoreA \vert HetA , d ) P ( homScoreB \vert HetA , d ) {n}_{FN}}{P ( hetScoreA \vert HomB , d ) P ( homScoreB \vert HomB , d ) {n}_{FP}}$$

Using Bayes' theorem again yields:

$$\begin{matrix}\begin{matrix}{L}_{A} = \frac{P ( HomB \vert hetScoreA , {c}_{h} )}{P ( HetA \vert hetScoreA , {c}_{h} )} \\ = \frac{P ( hetScoreA \vert HomB , {c}_{h} ) P ( HomB , {c}_{h} )}{P ( hetScoreA \vert HetA , {c}_{h} ) P ( HetA , {c}_{h} )} \frac{P ( hetScoreA \vert HomB , {c}_{h} )}{P ( hetScoreA \vert HetA , {c}_{h} )} \\ = {L}_{A} \frac{P ( HetA , {c}_{h} )}{P ( HomB , {c}_{h} )} \\ = {L}_{A} \frac{{n}_{TP}}{{n}_{FP}}\end{matrix} & ( 5 ) \\ \begin{matrix}{L}_{B} = \frac{P ( HetA \vert homScoreB , {c}_{r} )}{P ( HomB \vert homScoreB , {c}_{r} )} \\ = \frac{P ( homScoreB \vert HetA , {c}_{r} ) P ( HetA , {c}_{r} )}{P ( homScoreB \vert HomB , {c}_{r} ) P ( HomB , {c}_{r} )} \\ \frac{P ( homScoreB \vert HetA , {c}_{r} )}{P ( homScoreB \vert HomB , {c}_{r} )} \\ = {L}_{B} \frac{P ( HomB , {c}_{r} )}{P ( HetA , {c}_{r} )} \\ = {L}_{B} \frac{{n}_{TN}}{{n}_{Fn}}\end{matrix} & ( 6 )\end{matrix}$$

Now it is assumed that the score distribution for true variants is the same for discordant loci as for concordant loci, so that P(hetScoreA|HetA,d)=P(hetScoreA|HetA,cₕ), and likewise for the other score distributions of equations (4), (5), and (6). Then, plugging equations (4) and (5) into (6) gives:

$$\frac{P ( HetA \vert hetScoreA , homScoreB , d )}{P ( HomB \vert hetScoreA , homScoreB , d )} = \frac{{n}_{FP} {L}_{B} {n}_{TN} {n}_{FN}}{{L}_{A} {n}_{TP} {n}_{FN} {n}_{FP}}$$

$$\frac{P ( Het \vert hetScoreA , homScoreB , d )}{P ( Hom \vert hetScoreA , homScoreB , d )} = \frac{{L}_{B} {n}_{TN}}{{L}_{A} {n}_{TP}}$$

In the above equation, L_{A} and L_{B} are given as inputs to the iteration, and n_{TN} and n_{TP} are estimated empirically, for example, based on information associated with the set of true and false calls.

The above mathematical formulation can address a difference in the number of variant calls within a bucket for the first genome and the number of reference calls within a bucket for the second genome. Also, as reference calls are more frequent, the number of discordant loci within a bucket would be less of a percentage. But, since the issue is whether the discordant loci are false negatives, and not loci in general, the number of discordant loci in a bucket of references calls of the second genome should not be used directly.

D. Coverage Buckets

In practice, the likelihood of a false call for a given score is strongly dependent on local coverage. To model this behavior, the replicate calibration logic separates loci into bins by both coverage and score. The smoothing step of the iteration loop then smooths the logarithm of the error rate by score for each coverage bin. The calibration is reported for each coverage bin.

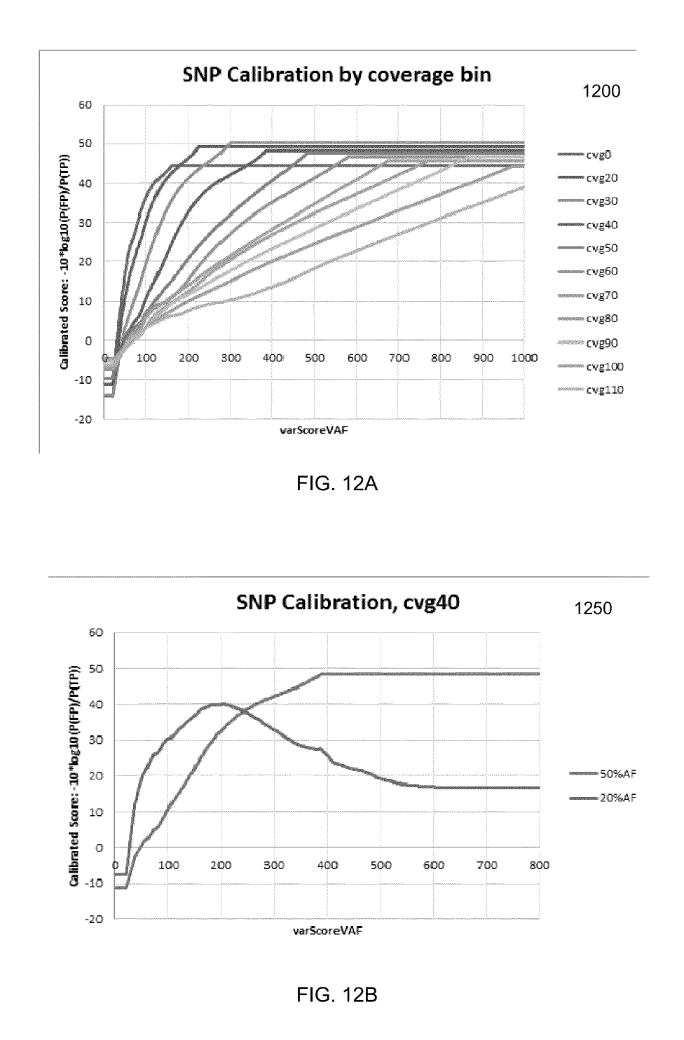

After smoothing, the per-coverage-bin calibration of SNPs looks as illustrated ing graph 1200 of FIG. 12A. In graph 1200, that coverage bins are labeled by the minimum coverage present in that bin. So for example, cvg0 references to the coverage bin with coverage between 0 and 19. Graph 1200 shows that the calibration scores vary with coverage. Graph 1200 also illustrates that due to lack of false events, the calibration cannot be estimated higher than some maximum calibrated score. Also, higher coverage bins have worse calibration curves. Just as with the curve in the calibration line, this is another indicator that the primary cause for variant errors at high score is events (DNBs) that are not generated in accordance with the expected model of DNB generation.

E. 20% AF Calibration of FP

A 20% allele fraction calibration is also provided for false positives using the varScoreVAF. This calibration indicates the error rate of variant calls, under the assumption that all heterozygous mutations in a genome are present at 20% allele fraction. The notation from the sub-section titled “Mathematical Model for Iterative Refinement of Score Calibration” is adopted, except that Het_{20% AF} is defined to be the condition that a given locus is heterozygous, assuming all heterozygous loci are present at 20% allele fraction and Het_{50% AF} is defined to be the condition that a locus is heterozygous, assuming all heterozygous loci are present at 50% allele fraction.

Applying the Bayes' theorem to the likelihood ratio gives:

$$\frac{P ( {Het}_{20 \% AF} \vert hetScoreA )}{P ( {Het}_{50 \% AF} \vert hetScoreA )} = \frac{P ( hetScoreA \vert {Het}_{20 \% AF} ) P ( {Het}_{20 \% AF} )}{P ( hetScoreA \vert {Het}_{50 \% AF} ) P ( {Het}_{50 \% AF} )}$$

Given that the scenario being considered is where the set of het calls is the same as would be expected in a typical genome, e.g. simply present at 20% AF it follows that P(Het_{20% AF})=P(Het_{50% AF}). Therefore:

$$P ( {Het}_{20 \% AF} \vert hetScoreA ) = P ( {Het}_{50 \% AF} \vert hetScoreA ) \frac{P ( hetScoreA \vert {Het}_{20 \% AF} )}{P ( hetScoreA \vert {Het}_{50 \% AF} )}$$

That is, P(Het_{50% AF}|hetScoreA) can simply be scaled by the score distribution ratio for true variants to get P(Het_{20% AF}|hetScoreA).

During score calibration, the score distribution of true variants is assessed for both allele fractions using the sample mixture assemblies. The true variants for 20% AF and 50% AF case are binned and their ratio is smoothed in the same manner as false and true variants are binned and their ratio is smoothed for calibration of 50% AF variants. This smoothed result is then applied to the 50% AF calibration to get the 20% AF calibration.

FIG. 12B is a graph 1250 illustrating an example of how the 20% AF calibration compares to the 50% AF calibration, for coverage 40-50. Graph 1250 illustrates that there is more confidence in variants at low score, if it is assumed that all variants are present at 20% allele fraction. In one embodiment, a somatic scoring logic uses this fact to improve the ROC for low allele fraction variants by using a mixture model where 50% of variants are present at 50% AF and 50% of variants are present at 20% AF.

### VII. Somatic Scoring

A cancer genome can often be highly aberrant with many variants, exacerbating the determination of whether a variant call is correct or due to an error. Since there can be sequencing errors, one can want to determine scoring mechanisms to distinguish false variations from true variations, particularly somatic variations due to cancer. To address these errors, embodiments can use information from a normal sample to subtract out the ‘noise’ from a tumor sample. Thus, one can determine a tumor genome and a normal genome to identify differences between the two.

However, simply comparing the two genomes can still provide errors. For example, assume that there is one error for every mB, which gives about 3,000 errors for the entire human genome. A tumor might have about 3,000 errors. Then 6,000 errors in total in the tumor sample and the normal sample. If 1,000 real somatic variations, then ⅙ of the identified variations are correct. Higher sequencing can reduce errors, but then certain variations might be more rare, which would cause problems with the error rate.

One could use variant scores and reference scores to analyze the discordant loci for somatic events. Such an analysis can provide a measure of sensitivity (as opposed to quality), by using a score distribution of germline variants. For example, one can assume that the score distribution of true variants is the same as the score distribution of called variants. But, it doesn't work so well when the distribution of scores is substantially different for somatic variants (e.g., if there is substantial normal contamination). Also, indels with a lower variant score than a SNP may have a higher value than the SNP.

To address this problem embodiments can use a likelihood that the discordance between the tumor genome and the normal genome is correct. In one embodiment, the false positive rate of the variant call and the false negative rate of the reference call may be used, e.g., as may be determined above as the calibration calls. These scores can be used to determine a somatic score that provides an indication that a discordance is correct. That is, for any discordant locus between tumor and normal, what is the likelihood that it is a true discordance, i.e., a true somatic event, as opposed to a false positive or false negative.

The somatic score can be based on other values, such as: total count of somatic events to determine likelihood that somatic mutation is an error. A total count of germline mutations can also be used. For SNPs, total count can be about 1,000. The estimate can be different for different tumors. Regardless, this value is simply a constant, and thus comparisons can be made based on relative scores.

In some embodiments, a somatic rank based on the somatic score may also be computed. For example, a somatic rank of 95% for a given variant (in a given somatic category such as SNP, insertion, deletion, substitution, etc.) indicates that 95% of all true variants have a somatic score that is worse than the score of the given variant.

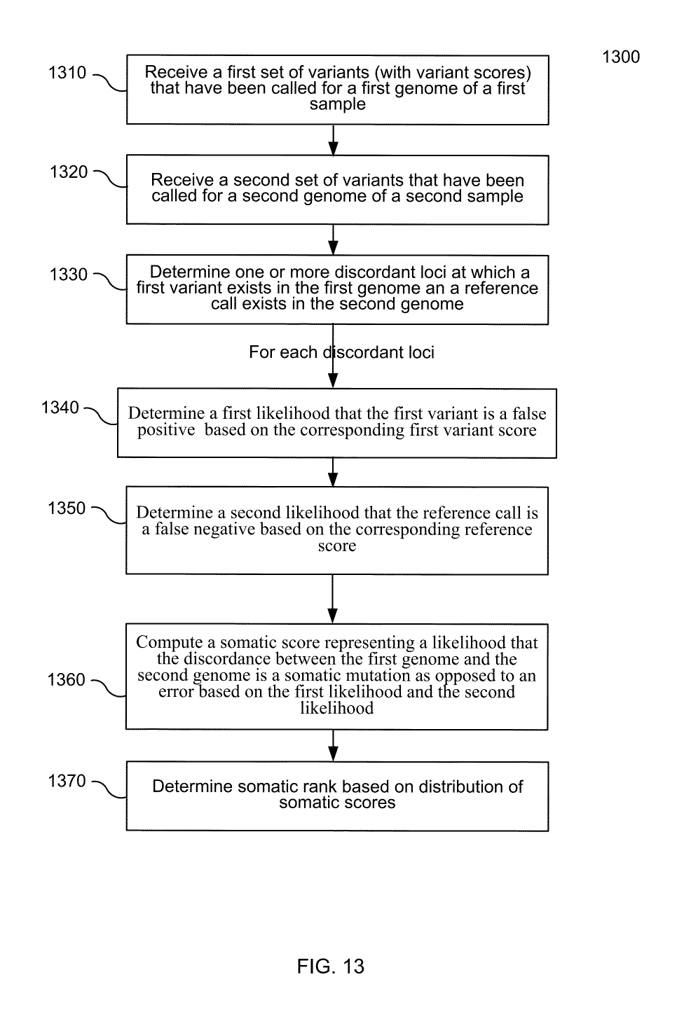

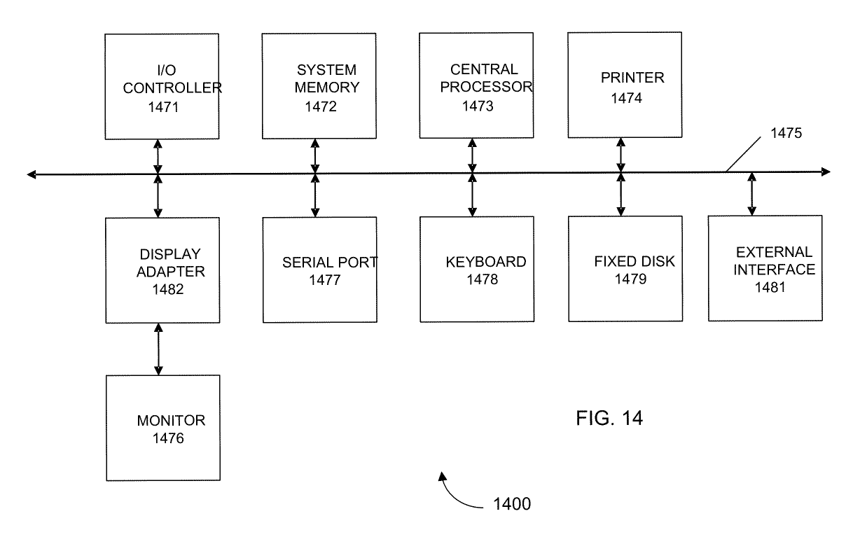

FIG. 13 is a flow diagram illustrating an example method 1300 of computing somatic scores according to one embodiment. Generally, a computer can take as input two genomes (from two different samples typically) and the variants that have been called for these two genomes with respect to a reference or a baseline genome. The computer system compares the two genomes and their variants to find the loci where the genomes disagree (i.e., the discordant loci). The computer system then determines a likelihood that the two genomes are truly in disagreement at a given locus. The determined likelihoods are then used to compute the new type of somatic score for this locus.

At block 1310, a computer system receives first variants that have been called for a first genome based on a sequencing of a first sample. In one embodiment, these first variants can be for a tumor sample (e.g., cancer cells) from an organism (e.g., a human or other mammal). First variant scores for the first variants are received for computing a likelihood that a variant call is correct.

At block 1320, the computer system receives a second set of variants that have been called for a second genome based on a sequencing of a second sample. In one embodiment, these second variants can be for a normal sample from the organism. Thus, the second genome can be a baseline genome that has been sequenced from fragments extracted from normal cells of the same organism as in block 1310. Second variant scores for the second variants may be received. In some embodiments, the variants for the first genome and the variants for the second genome are small variants.

At block 1330, the computer system determines one or more discordant loci at which a first variant exists in the first genome an a reference call exists in the second genome based on the first set of variants and the second set of variants. The discordant loci can be analyzed to determine whether the first variant calls are likely to be somatic mutations or not. Blocks 1340-1360 can be determined for each discordant loci.

At block 1340, a first likelihood that the first variant is a false positive is determined based on the corresponding first variant score. In one embodiment, the first likelihood corresponds to a variant calibrated score as described above. For example, the variant score can be used to access a database table to retrieve a variant calibrated score that corresponds to the first variant score. Other information may be used to determine the first likelihood. Such information may include, but is not limited to, coverage information (e.g., such as raw read counts and mappings counts), variant type, and allele fraction.

At block 1350, a second likelihood that the reference call is a false negative is determined based on the corresponding reference score. In one embodiment, the second likelihood corresponds to a reference calibrated score as described above. For example, the reference score can be used to access a database table to retrieve a reference calibrated score that corresponds to the reference score.

At block 1360, the computer system computes a somatic score representing a likelihood that the discordance between the first genome and the second genome is a somatic mutation as opposed to an error based on the first likelihood and the second likelihood. Examples of a possible error are a sequencing error or a library preparation error. The computer system can compute the somatic score based on coverage information and other metrics described herein.

At block 1370, a somatic rank can be determined based on distribution of somatic scores. In some embodiments, a somatic rank is a number between 0 and 1 that indicates the expected rank of a somatic variant amongst true somatic variants. For example, based on the distribution of somatic scores, one can determine that some fraction of variants detected in a sample have a particular somatic score or lower (e.g., 5% of variants may have a score <=20). A same type of score can also be applied as a measure for loci in a corresponding reference. Then, the variant scores and the reference scores are combined to obtain the somatic scores for various subsets of the variants. For example, a threshold of 0.01 can be used for the variant scores and the same or a different threshold can be used for the reference scores. The somatic rank can expresses a percentage of the regions in the genome where both the variant scores and the reference scores are above their respective thresholds. In one embodiment, only heterozygous variants are considered when determining the somatic rank.

A. Computing the Somatic Likelihood Ratio and Somatic Score

Given a locus where genome A (e.g. the “tumor” genome) has a variant call and genome B (e.g. the “normal” genome) has a reference call, a computer logic determines the likelihood that the discordance is a true difference between the genomes. The computer logic uses the score information (specifically, the calibrated likelihood ratios L_{A} and L_{B} as determined by replicate calibration that is run separately for genome A and separately for genome B) to estimate this likelihood.

The calibrated scores (e.g., as provided by replicate calibration separately for genome A and genome B) allow for determining the likelihood ratios L_{A} and L_{B}, which are a measure of the likelihood the variant call in genome A is false (FP_{A}) or true (TP_{A}) given the raw score information (v_{A}), and the likelihood the reference call in genome B is false (FN_{B}) or true (TN_{B}) given the raw score information (r_{B}). The likelihood ratios are defined as follows:

$${L}_{A} = \frac{P ( {FP}_{A} \vert {v}_{A} )}{P ( {TP}_{A} \vert {v}_{A} )}$$

$${L}_{B} = \frac{P ( {FN}_{A} \vert {r}_{B} )}{P ( {TN}_{B} \vert {r}_{B} )}$$

Given this, the somatic likelihood ratio given the raw score information for the calls, Lₛₒₘ, is determined as follows:

$$\begin{matrix}{L}_{som} = \frac{P ( not somatic \vert {v}_{A} , {r}_{B} )}{P ( somatic \vert {v}_{A} , {r}_{B} )} \\ = \frac{P ( {FP}_{A} , {TN}_{B} \vert {v}_{A} , {r}_{B} ) + P ( {TP}_{A} , {FN}_{B} \vert {v}_{A} , {r}_{B} )}{P ( {TP}_{A} , {TN}_{B} \vert {v}_{A} , {r}_{B} )} \\ = \frac{P ( {FP}_{A} \vert {TN}_{B} , {v}_{A} , {r}_{B} ) P ( {TN}_{B} \vert {v}_{A} , {r}_{B} )}{P ( {TP}_{A} , {TN}_{B} \vert {v}_{A} , {r}_{B} )} + \\ \frac{P ( {FN}_{B} \vert {TP}_{A} , {v}_{A} , {r}_{B} , d ) P ( {TP}_{A} \vert {v}_{A} , {r}_{B} )}{P ( {TP}_{A} , {TN}_{B} \vert {v}_{A} , {r}_{B} )} \\ = \frac{P ( {FP}_{A} \vert {TN}_{B} , {v}_{A} , {r}_{B} ) P ( {TN}_{B} \vert {v}_{A} , {r}_{B} )}{P ( {TP}_{A} \vert {TN}_{B} , {v}_{A} , {r}_{B} ) P ( {TN}_{B} \vert {v}_{A} , {r}_{B} )} + \\ \frac{P ( {FN}_{B} \vert {TP}_{A} , {v}_{A} , {r}_{B} , d ) P ( {TP}_{A} \vert {v}_{A} , {r}_{B} )}{P ( {TN}_{B} \vert {TP}_{A} , {v}_{A} , {r}_{B} , d ) P ( {TP}_{A} \vert {v}_{A} , {r}_{B} )} \\ = \frac{P ( {FP}_{A} \vert {TN}_{B} , {v}_{A} , {r}_{B} )}{P ( {TP}_{A} \vert {TN}_{B} , {v}_{A} , {r}_{B} )} + \frac{P ( {FN}_{B} \vert {TP}_{A} , {v}_{A} , {r}_{B} )}{P ( {TN}_{B} \vert {TP}_{A} , {v}_{A} , {r}_{B} )}\end{matrix}$$

By Bayes' theorem the last quantity is equal to:

$$= \frac{P ( {TN}_{B} , {v}_{A} , {r}_{B} \vert {FP}_{A} ) P ( {FP}_{A} )}{P ( {TN}_{B} , {v}_{A} , {r}_{B} \vert {TP}_{A} ) P ( {TP}_{A} )} + \frac{P ( {TP}_{A} , {v}_{A} , {r}_{B} \vert {FN}_{B} ) P ( {FN}_{B} )}{P ( {TP}_{A} , {v}_{A} , {r}_{B} \vert {TN}_{B} ) P ( {TN}_{B} )}$$

By independence assumptions, the last quantity is equal to:

$$= \frac{P ( {TN}_{B} \vert {FP}_{A} ) P ( {r}_{B} \vert {FP}_{A} ) P ( {v}_{A} \vert {FP}_{A} ) P ( {FP}_{A} )}{P ( {TN}_{B} \vert {TP}_{A} ) P ( {r}_{B} \vert {TP}_{A} ) P ( {v}_{A} \vert {TP}_{A} ) P ( {TP}_{A} )} + \frac{P ( {TP}_{A} \vert {FN}_{B} ) P ( {v}_{A} \vert {FN}_{B} ) P ( {r}_{B} \vert {FN}_{B} ) P ( {FN}_{B} )}{P ( {TP}_{A} \vert {TN}_{B} ) P ( {v}_{A} \vert {TN}_{B} ) P ( {r}_{B} \vert {TN}_{B} ) P ( {TN}_{B} )}$$

Assuming that the score distribution in genome B does not depend on the call in genome A, and vice versa, the following probability expressions are obtained:

P(r_{B}|FP_{A})=P(r_{B}|TP_{A}) and P(V_{A}|FN_{B})=P(V_{A}|TN_{B}).

Thus:

$${L}_{som} = \frac{P ( {TN}_{B} \vert {FP}_{A} ) P ( {v}_{A} \vert {FP}_{A} ) P ( {FP}_{A} )}{P ( {TN}_{B} \vert {TP}_{A} ) P ( {v}_{A} \vert {TP}_{A} ) P ( {TP}_{A} )} + \frac{P ( {TP}_{A} \vert {FN}_{B} ) P ( {r}_{B} \vert {FN}_{B} ) P ( {FN}_{B} )}{P ( {TP}_{A} \vert {TN}_{B} ) P ( {r}_{B} \vert {TN}_{B} ) P ( {TN}_{B} )} \qquad ( 7 )$$

Applying Bayes' theorem to the definition of L_{A} and L_{B} from above yields:

$${L}_{A} = \frac{P ( {FP}_{A} \vert {v}_{A} )}{P ( {TP}_{A} \vert {v}_{A} )} = \frac{P ( {v}_{A} \vert {FP}_{A} ) P ( {FP}_{A} )}{P ( {v}_{A} \vert {TP}_{A} ) P ( {TP}_{A} )}$$

$${L}_{B} = \frac{P ( {FN}_{B} \vert {r}_{B} )}{P ( {TN}_{B} \vert {r}_{B} )} = \frac{P ( {r}_{B} \vert {FN}_{B} ) P ( {FN}_{B} )}{P ( {r}_{B} \vert {TN}_{B} ) P ( {TN}_{B} )}$$

Plugging this into equation (7) above, gives:

$${L}_{som} = {L}_{A} \frac{P ( {TN}_{B} \vert {FP}_{A} )}{P ( {TN}_{B} \vert {TP}_{A} )} + {L}_{B} \frac{P ( {TP}_{A} \vert {FN}_{B} )}{P ( {TP}_{A} \vert {TN}_{B} )}$$

In one embodiment, P(TN_{B}|FP_{A}) is estimated as equal to 1, i.e. P(TN_{B}|FP_{A})=1. The same estimate is made for P(TP_{A}|FN_{B}), i.e. P(TP_{A}|FN_{B})=1. Additionally, nₛₒₘ is defined to be the count of true somatic loci, n_{TP,A} is defined to be the count of true variants in genome A, and n_{TN,B} is defined to be the total count of true reference positions in B. Thus:

$$P ( {TN}_{B} \vert {TP}_{A} ) = \frac{{n}_{som}}{{n}_{TP , A}}$$

$$P ( {TP}_{A} \vert {TN}_{B} ) = \frac{{n}_{som}}{{n}_{TN , B}}$$

Therefore,

$${L}_{som} = {L}_{A} \frac{{n}_{TP , A}}{{n}_{som}} + {L}_{B} \frac{{n}_{TN , B}}{{n}_{som}} \qquad ( 8 )$$

where the values L_{A} and L_{B} are obtained by performing replicate calibration separately for genome A and separately for genome B (as described in Section V below).

Given the derivation of Lₛₒₘ above, the new-type somaticScore is defined and computed as follows:

SomaticScore=−10 log₁₀Lₛₒₘ.

In computing the somatic score, the following additional assumptions can made: rate of somatic SNP is 1 per Mb; rate of somatic insertion is 1 per 10 Mb; rate of somatic deletion is 1 per 10 Mb; and rate of somatic substitution is 1 per 20 Mb. In other embodiments, the rate of each of these somatic variants can be determined empirically. With additional knowledge of the true rate of somatic mutation, it should be straightforward to scale the somatic score to better reflect this reality, according to equation (8) above.

B. Diploid Option

When using a diploid option, logic uses the calibration of the EAF model, and additionally assumes that all germline heterozygous and somatic variants are present at 50% allele fraction. Without the diploid option, logic uses the calibration of the VAF and assumes a mixture model, where half the germline heterozygous and somatic variants are present at 50% allele fraction and half are present at a lower (e.g. 20%) allele fraction. This effectively increases the confidence in lower scoring variants, such as would be the case for somatic variants of low allele fraction.

To illustrate, suppose mix=m is defined to be the condition that the variants in genome A contain a mixture of 20% allele fraction and 50% allele fraction, with m being the fraction of variants present at 20% allele fraction. Then, L_{A,mix=m} is defined as:

$$\begin{matrix}{L}_{A , mix = m} = \frac{P ( {FP}_{A} \vert {v}_{A} , mix = m )}{P ( {TP}_{A} \vert {v}_{A} , mix = m )} \\ = \frac{P ( {v}_{A} , mix = m \vert {FP}_{A} ) P ( {FP}_{A} )}{P ( {v}_{A} , mix = m \vert {TP}_{A} ) P ( {TP}_{A} )} \\ = \frac{P ( {v}_{A} , mix = m \vert {FP}_{A} )}{mP ( {v}_{A} , mix = 1 \vert {TP}_{A} ) + ( 1 - m ) P ( {v}_{A} , mix = 0 \vert {TP}_{A} )} \frac{P ( {FP}_{A} )}{P ( {TP}_{A} )}\end{matrix}$$

Next, it is assumed that P(v_{A}, mix=m|FP_{A})=P(v_{A}, mix=0|FP_{A})=P(v_{A}, mix=1|FP_{A}). That is, the score distribution of false calls does not depend on the mixture fraction m. Thus,

$${L}_{A , mix = m} = \frac{1}{\begin{matrix}m \frac{P ( {v}_{A} , mix = 1 \vert {TP}_{A} ) P ( {TP}_{A} )}{P ( {v}_{A} , mix = 1 \vert {FP}_{A} ) P ( {FP}_{A} )} + \\ ( 1 - m ) \frac{P ( {v}_{A} , mix = 0 \vert {TP}_{A} ) P ( {TP}_{A} )}{P ( {v}_{A} , mix = 0 \vert {FP}_{A} ) P ( {FP}_{A} )}\end{matrix}}$$

$${L}_{A , mix = m} = \frac{1}{\frac{m}{{L}_{A , mix = 1}} + \frac{1 - m}{{L}_{A , mix = 0}}}$$

The derivation illustrated above is easily extended for mixtures of more than two sets of variants with differing allele fraction. In an example embodiment, the value of m can be set to 0.5 (i.e., m=0.5) and the value of L_{A,mix=m} can used as the value of L_{A} in equation (8) above to compute the value of Lₛₒₘ.

### VIII. Computer System

Any of the computer systems mentioned herein may utilize any suitable number of subsystems. Examples of such subsystems are shown in FIG. 6 in computer apparatus 600. In some embodiments, a computer system includes a single computer apparatus, where the subsystems can be the components of the computer apparatus. In other embodiments, a computer system can include multiple computer apparatuses, each being a subsystem, with internal components.

The subsystems shown in FIG. 6 are interconnected via a system bus 675. Additional subsystems such as a printer 674, keyboard 678, storage device(s) 679, monitor 676, which is coupled to display adapter 682, and others are shown. Peripherals and input/output (I/O) devices, which couple to I/O controller 671, can be connected to the computer system by any number of means known in the art, such as serial port 677. For example, serial port 677 or external interface 681 (e.g. Ethernet, Wi-Fi, etc.) can be used to connect computer system 600 to a wide area network such as the Internet, a mouse input device, or a scanner. The interconnection via system bus 675 allows the central processor 673 to communicate with each subsystem and to control the execution of instructions from system memory 672 or the storage device(s) 679 (e.g., a fixed disk), as well as the exchange of information between subsystems. The system memory 672 and/or the storage device(s) 679 may embody a computer readable medium. Any of the values mentioned herein can be output from one component to another component and can be output to the user.

A computer system can include a plurality of the same components or subsystems, e.g., connected together by external interface 681 or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g. an application specific integrated circuit or field programmable gate array) and/or using computer software with a generally programmable processor in a modular or integrated manner. As user herein, a processor includes a multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer program product (e.g. a hard drive, a CD, or an entire computer system), and may be present on or within different computer program products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, circuits, or other means for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary.

All patents, patent applications, publications, and descriptions mentioned here are incorporated by reference in their entirety for all purposes. None is admitted to be prior art.

What is claimed is:

1. A method of determining one or more variants between a reference genome and a sample genome of a biological sample from a diploid organism, the method comprising:
receiving reads of the sample genome and mappings of the reads to the reference genome, wherein the reads are obtained from a sequencing of a plurality of genomic fragments from the biological sample;
identifying a first region of the sample genome, the first region having a first likelihood of including one or more variants relative to a corresponding region in the reference genome, the first likelihood being above a first threshold;
determining a starting hypothesis of the sample genome in the first region;
based on the starting hypothesis, generating a group of hypotheses, each of the sample genome in the first region, wherein at least one of the group of hypotheses includes a plurality of alleles and a respective allele fraction corresponding to each of the plurality of alleles;
for each hypothesis in the group of hypotheses:
computing a probability score for the hypothesis using a probability function, the probability function receiving an input of each allele of the hypothesis and the respective allele fraction,
wherein a first hypothesis in the group of hypotheses includes a first allele with a respective allele fraction between a minimum threshold fraction and 0.5;
selecting a top hypothesis based on the probability scores; and
calling, for the first region, one or more variants between the reference genome and the sample genome based on the top hypothesis,
wherein the method is performed by one or more computing devices.

2. The method of claim 1, wherein generating the first hypothesis includes:
determining a percentage of reads having the first allele at the first region; and
using the percentage as the respective allele fraction for the first hypothesis.

3. The method of claim 1, wherein generating the first hypothesis includes:
computing a probability score for each of a plurality of allele fractions for the first allele; and
selecting the allele fraction that provides the highest probability score as the respective allele fraction for the first allele.

4. The method of claim 1, wherein computing a probability score of a hypothesis of the at least one of the group of hypotheses comprises:
evaluating one or more conditions for the hypothesis;
when the one or more conditions are satisfied, computing a score for the hypothesis by using variable allele fraction values for the plurality of alleles;
when the one or more conditions are not satisfied, computing the score for the hypothesis by using equal allele fraction values for the plurality of alleles;

5. The method of claim 1, wherein the minimum threshold fraction is 0 or 0.2.

6. The method of claim 1, further comprising:
determining the respective allele fraction of the first allele of the first hypothesis as an optimal input value for the probability function.

7. The method of claim 1, wherein the biological sample includes cells having different genomes, and wherein the sample genome is a composite genome of the different genomes.

8. The method of claim 1, wherein the one or more variants include SNPs or indels of less than 100 bases.

9. The method of claim 1, wherein evaluating the one or more conditions comprises determining whether the variable allele fraction values for the one or more alleles exceed a threshold value.

10. The method of claim 1, wherein evaluating the one or more conditions comprises determining whether a maximum likelihood probability of the hypothesis exceeds, by a threshold value, the probability of a homozygous hypothesis for the region.

11. The method of claim 1, wherein evaluating the one or more conditions comprises:
determining whether the variable allele fraction values for the one or more alleles exceed a first threshold value; and
determining whether a maximum likelihood probability for the hypothesis exceeds, by a second threshold value, the probability of a homozygous hypothesis for the region.

12. The method of claim 1, further comprising:
generating a triploid hypothesis for the region based on alleles of the two diploid hypotheses that have the top two scores;
evaluating the triploid hypothesis by computing a triploid hypothesis score; and
selecting the triploid hypothesis as the top hypothesis when the triploid hypothesis score exceeds, by a threshold value, the higher of the scores of the two diploid hypothesis.

13. The method of claim 1, wherein determining the starting hypothesis for the region comprises:
generating multiple hypotheses based on one or more of: a reference hypothesis for the region; a subset of hypotheses discovered as plausible by using a local de novo assembly of the region; and a subset of hypotheses derived from a database of known variants for the region; and
selecting the starting hypothesis from the multiple hypotheses.

14. The method of claim 1, wherein generating the group of hypotheses comprises:
including, in the group of hypotheses, at least some hypotheses that have a one-base difference from the starting hypothesis.

15. The method of claim 1, further comprising:
identifying multiple regions, in the genome of the biological sample, that are likely to include variants with respect to corresponding regions in the reference genome; and
for each of the multiple regions, repeating the steps of determining, generating, scoring, selecting, and calling.

16. The method of claim 1, wherein selecting the top hypothesis comprises performing one or more iterations that include:
if a particular hypothesis in the group of hypotheses has a better score than the score computed for the starting hypothesis, then setting the particular hypothesis as a new starting hypothesis and repeating the steps of generating and scoring for the new starting hypothesis.

17. The method of claim 1, further comprising:
rescoring the group of hypotheses, from which a particular variant was determined for the first region, based on a parameter that indicates the likelihood that any given variant in the first region is not present in a target nucleic acid fragment but was generated by a library preparation process prior to sequencing, wherein:
a first value of the parameter is used when two alleles in a particular hypothesis, of the group of hypotheses, differ by a one-base indel; and
a second value of the parameter is used when the difference between the two alleles is not a one-base indel.

18. The method of claim 1, further comprising:
calling, for other regions, one or more variants between the reference genome and the sample genome based on a top hypothesis for the other regions that have been identified as having likelihood of including a variant that is above a first threshold.

19. A computer product comprising a non-transitory computer readable medium storing a plurality of instructions that when executed control a computer system to determine one or more variants between a reference genome and a sample genome of a biological sample from a diploid organism, the instructions comprising:
receiving reads of the sample genome and mappings of the reads to the reference genome, wherein the reads are obtained from a sequencing of a plurality of genomic fragments from the biological sample;
identifying a first region of the sample genome, the first region having a first likelihood of including one or more variants relative to a corresponding region in the reference genome, the first likelihood being above a first threshold;
determining a starting hypothesis of the sample genome in the first region;
based on the starting hypothesis, generating a group of hypotheses, each of the sample genome in the first region, wherein at least one of the group of hypotheses includes a plurality of alleles and a respective allele fraction corresponding to each of the plurality of alleles;
for each hypothesis in the group of hypotheses:
computing a probability score for the hypothesis using a probability function, the probability function receiving an input of each allele of the hypothesis and the respective allele fraction,
wherein a first hypothesis in the group of hypotheses includes a first allele with a respective allele fraction between a minimum threshold fraction and 0.5;
selecting a top hypothesis based on the probability scores; and
calling, for the first region, one or more variants between the reference genome and the sample genome based on the top hypothesis.

20. A method of determining an error rate for a variant call in a genome of a sample, the method comprising:
receiving first variant calls and corresponding first variant scores, wherein the first variant calls have been called for a first genome that has been sequenced from a sample in a first sequencing operation;
receiving second variant calls, wherein the second variant calls have been called for a second genome that has been sequenced from the same sample in a second sequencing operation that is different than the first sequencing operation;
based at least on the first variant calls and the second variant calls, determining discordant loci at which there are discordances between the first genome and the second genome;
grouping the first variants based on the first variant scores into a first set of groups;
determining a variation calibration score indicating a likelihood of a variant being a false positive for each group of the first set; and
storing the variation calibration scores for each group, wherein the method is performed by one or more computing devices.

21. The method of claim 20, further comprising:
grouping the first variants further based on a read coverage of loci in a group, wherein each group in the first set corresponds to a different combination of a range of variant scores and a range of read coverage.

22. The method of claim 20, wherein determining a likelihood of a variant being a false positive for each group of the first set includes:
assigning an initial variation calibration score to each group of the first set;
for each discordant loci:
determining a probability P(H) that the variant call is correct using the variant calibration score of the group corresponding to the respective discordant loci; and
for each group in the first set:
determining new variation calibration scores for each group by computing a value based on the P(H) of each discordant loci in the respective group.

23. The method of claim 22, further comprising:
prior to determining the new variation calibration scores, changing the groups of the first set for the variant calls of the first genome.

24. The method of claim 23, wherein each changed group has an expected value of at least 10 false and 10 true variant calls out of the discordant loci for the respective group.

25. The method of claim 22, further comprising:
repeating determining the probabilities P(H) for each discordant locus and determining new variation calibration scores until the variation calibration scores converges or a limit is reached.

26. The method of claim 22, further comprising:
assigning an initial reference calibration score to each group of the second set;
receiving reference calls and corresponding reference scores for the second genome;
grouping reference calls based on the reference scores into a second set of groups, wherein determining the probability P(H) for a discordant loci includes:
comparing the variant calibration score of the corresponding group of the first set to the reference calibration score of the second set; and
for each group in the second set:
determining new reference calibration scores for each group by computing a value based on the P(H) of each discordant loci in the respective group.

27. The method of claim 26, wherein the reference calibration scores for each group of the second set are stored in a table, the method further comprising:
receiving a first reference score for a first reference call determined from a sequencing operation of a different sample; and
using the first reference score to access the table to obtain a reference calibration score corresponding to the first reference score, the reference calibration score indicating a likelihood that the first reference call is correct.

28. The method of claim 20, wherein the variation calibration scores for each group are stored in a table, the method further comprising:
receiving a third variation score for a third variant call determined from a sequencing operation of a different sample; and
using the third variation score to access the table to obtain a variation calibration score corresponding to the third variation score, the variation calibration score indicating a likelihood that the third variant call is correct.

29. The method of claim 20, wherein the first variant calls and the second variant calls identify variants of a same type.

30. A method of determining an error rate for a variant call in a genome of a sample, the method comprising:
receiving reads of the sample genome and mappings of the reads to the reference genome, wherein the reads are obtained from a sequencing of a plurality of genomic fragments from the biological sample;
identifying a first region of the sample genome, the first region having a first likelihood of including one or more variants relative to a corresponding region in the reference genome, the first likelihood being above a first threshold;
determining a top hypothesis based on the probability scores of a plurality of hypotheses in the first region;
calculating a first variant score based on the top hypothesis and at least one other hypothesis; and
using the first variant score to access a database table to obtain a calibrated score indicating an error rate for the top hypothesis, the calibrated score corresponding to a range of variant scores that includes the first variant score, wherein the method is performed by one or more computing devices.

31. A method of identifying a somatic mutation in a first sample, the method comprising:
receiving a first set of variants with first variant scores that have been called for a first genome based on a sequencing of a first sample;
receiving a second set of variants with second variant scores that have been called for a second genome based on a sequencing of a second sample;
based on the first set of variants and the second set of variants, determining one or more discordant loci at which a first variant exists in the first genome and a reference call exists in the second genome; and
for each of the discordant loci:
determining a first likelihood that the first variant is a false positive based on the corresponding first variant score;
determining a second likelihood that the reference call is a false negative based on the corresponding reference score; and
computing a somatic score representing a likelihood that the discordance between the first genome and the second genome is a somatic mutation as opposed to an error based on the first likelihood and the second likelihood,
wherein the method is performed by one or more computing devices.

32. The method of claim 31, wherein the error includes a sequencing or library-preparation error.

33. The method of claim 31, wherein:
the first genome has been sequenced from first fragments extracted from tumor cells of an organism; and
the second genome has been sequenced from second fragments extracted from normal cells of the organism.

34. The method of claim 33, wherein the organism is a human.

35. The method of claim 31, wherein the first set of variants and the second set of variants are of a same type.


SEQUENCE LISTING (8 sequences)

SEQ ID NO: 1 - DNA, 12 bp, Artificial Sequence
  synthetic diploid and triploid genome haplotype I
agttaacaagac

SEQ ID NO: 2 - DNA, 16 bp, Artificial Sequence
  synthetic heterogeneous sample het SNP loci first allele
tgattacagttaacaa

SEQ ID NO: 3 - DNA, 16 bp, Artificial Sequence
  synthetic heterogeneous sample het SNP loci second allele
tgattacagttagcaa

SEQ ID NO: 4 - DNA, 12 bp, Artificial Sequence
  synthetic diploid and triploid genome haplotype II
agttagcaagac

SEQ ID NO: 5 - DNA, 16 bp, Artificial Sequence
  synthetic heterogeneous sample het SNP loci third allele
tgatcacagttagcaa

SEQ ID NO: 6 - DNA, 15 bp, Artificial Sequence
  synthetic top hypothesis (score 100) with heterozygous one-base deletion
acagaaaaaaaatgc

SEQ ID NO: 7 - DNA, 16 bp, Artificial Sequence
  synthetic top hypothesis (score 100), reference hypothesis (score 0)
acagaaaaaaaaatgc

SEQ ID NO: 8 - DNA, 14 bp, Artificial Sequence
  synthetic next hypothesis (score 30)
acagaaaaaaatgc